(19) United States
(12) Patent Application Publication
(10) Pub. No.: US 2017/0024053 A1
(43) Pub. Date: Jan. 26, 2017

(54) TOUCH ALPHABET AND COMMUNICATION SYSTEM

(71) Applicant: ROBERT H. DUFFIELD, COEUR D'ALENE, ID (US)

(72) Inventor: ROBERT H. DUFFIELD, COEUR D'ALENE, ID (US)

(21) Appl. No.: 15/062,330

(22) Filed: Mar. 7, 2016

Related U.S. Application Data
(63) Continuation-in-part of application No. 14/552,350, filed on Nov. 24, 2014, now Pat. No. 9,280,229.
Application No. 14/552,350 is a continuation of application No. 13/475,883, filed on May 18, 2012, now Pat. No. 8,896,555.
(60) Provisional application No. 61/488,703, filed on May 20, 2011.

(51) Int. Cl. G06F 3/041; G06F 3/023; G06F 3/0488

(52) U.S. Cl. CPC G06F 3/0416; G06F 3/04883; G06F 3/0233; G06F 2203/04104; G06F 2203/04808

(57) ABSTRACT

A touch alphabet and communication system is provided. The communication system uses a predetermined set of touch gestures, such as fingertip touch patterns performable on keyless touch-sensitive surfaces, to express the user's desired communication. The touch-sensitive surface may be the touch screen display of a computer, tablet device, cell phone, or a touch-sensitive pad, for example. The finger touch patterns are based on a limited set of unique and ergonomically pleasing finger positions that may be performed in a limited area. The touch alphabet allows the user to comprehensively communicate without looking at the communication device, and with just one hand, or in another implementation, with two hands. Thus, a user can comfortably tap an entire alphabet and related functions, with one hand, without having to visualize the user interface surface or hunt for individual keys.

### RELATED APPLICATIONS

This continuation-in-part patent application claims the benefit of priority to U.S. patent application Ser. No. 14/552,350 to Duffield, filed Nov. 24, 2014, which in turn claims the benefit of priority to U.S. patent application Ser. No. 13/475,883 to Duffield, filed May 18, 2012, now U.S. Pat. No. 8,896,555, which in turn claims the benefit of priority to U.S. Provisional Patent Application No. 61/488,703 to Duffield, entitled “Touch Alphabet and Communication System,” filed May 20, 2011, all of these incorporated herein by reference in their entireties.

### BACKGROUND

Personal electronic devices provide enjoyment and utility for all ages. Available interfaces between humans and devices, however, remain limiting. Input devices and user interfaces for computers, cell phones, and other electronics remain a bottleneck with respect to speed and ease of use, and usually require a level of manual dexterity. Conventional keyboards, touch screens, and computer mice require at least some training, and remain a cumbersome link between the nimbleness of human thought and the brute speed of an electronic processor. Speech recognition and visual gesture recognition that generate digital input for devices are improvements, but humans can think and speak much faster than most input devices can capture, and electronic devices can process data much faster that human input devices can send. Thus, there is a gap between the world of humans and the electronic devices they use.

Contrary to expectations, providing an easy user interface for electronic communication devices has become more difficult as the devices have become more sophisticated. Increased processing power provides smaller devices and increased mobility. Thus, the physical footprint of the human interface has merely become smaller, not always better. The reduced size often requires even more manual dexterity and more focus in order to generate accurate input. The miniaturized “qwerty” keyboard of a cell phone is very compact, an advantage, but requires a great deal of focus to achieve both speed and satisfactory accuracy of the message being created. Typing is sometimes performed with two thumbs. Touching icons on a display to actuate functions is an improvement over typing individual letters, but when a human-readable message needs to be generated, the cell phone or tablet device often pops up a virtual qwerty-style keyboard in miniature.

### SUMMARY

A touch alphabet and communication system is provided. The communication system uses a predetermined set of touch gestures, such as fingertip touch patterns performable on keyless touch-sensitive surfaces, to express the user's desired communication. The touch-sensitive surface may be the touch screen display of a computer, tablet device, cell phone, or a touch-sensitive pad, for example. The finger touch patterns are based on a limited set of unique and ergonomically pleasing finger positions that may be performed in a limited area. The touch alphabet allows the user to comprehensively communicate without looking at the communication device, and with just one hand, or in another implementation, with two hands. Thus, a user can comfortably tap an entire alphabet and related functions, with one hand, without having to visualize the user interface surface or hunt for individual keys.

This summary section is not intended to give a full description of touch alphabets and communication systems. A detailed description with example implementations follows.

### BRIEF DESCRIPTION OF THE DRAWINGS

FIG. 1 is a diagram of example texting using a touch alphabet.

FIG. 2 is a block diagram of an example environment for practicing the touch alphabet and communication system.

FIG. 3 is a block diagram of an example touch communication engine.

FIG. 4 is a diagram of an example scheme for utilizing sensor areas in a keyless region.

FIG. 5 is a diagram of example keyless regions implemented on popular device display footprints.

FIGS. 6-16 are diagrams of a set of touch patterns that constitute an example database of “one-handed” finger-touch patterns.

FIG. 17 is a diagram of example keyless region scaling.

FIGS. 18-24 are diagrams of a set of touch patterns that constitute an example database of finger-touch patterns for the right hand.

FIG. 25 is a diagram of symmetry between left-handed and right-handed implementations of an example system.

FIG. 26 is a diagram of example texting using a two-handed implementation of the system.

FIG. 27 is a diagram of two-handed registration of keyless regions for user input.

FIG. 28 is a flow diagram of an example method of using a touch alphabet.

FIG. 29 is a diagram of an example input device and touch alphabet system in which the touch alphabet allows the user to comprehensively communicate with just one hand, and without looking at the input device.

FIG. 30 is a block diagram of an example touchscreen input device with multiple instances of an area for texting the touch alphabet designated, wherein each instance of the area adds a different typographical emphasis to the touch pattern sensed, such as a letter “t” in normal, italics, bold, and underlined.

FIG. 31 is a diagram of an example touchscreen input device wherein each instance of an area designated for texting the touch patterns senses a same set of the touch patterns but assigns characters from a respective different part of the alphabet to the touch patterns sensed in the respective instance of the area for sensing.

FIG. 32 is a flow diagram of an example method of creating multiple instances of the area for texting the touch patterns in different locations on a single touchscreen, wherein each different instance of the area for sensing the touch patterns adds a different typographical emphasis to an assigned character of a touch pattern sensed by the respective area, or, wherein an alphabet is divided across the multiple instances of the area for sensing the touch patterns.

### DETAILED DESCRIPTION

### Overview

This disclosure describes a touch alphabet and communication system. In one implementation, the communication system uses a predetermined set of touch gestures, such as finger touch placements and finger touch combinations, performable on various keyless touch-sensitive surfaces, to express the user's desired communication. The touch alphabet allows the user to comprehensively communicate without looking at the communication device, and with just one hand, although in one implementation, two hands may be used. Thus, a user can comfortably tap an entire alphabet and related functions, with one hand, without having to visualize the user interface surface (i.e., without having to look at the touch surface and without having to hunt for individual keys).

Keyless, as used herein, means that the surface that constitutes the touch input or communication interface does not require visible or actual key areas, as on a keyboard, and also does not have such discrete keys assigned in 1:1 relationship with individual finger strokes or individual touches for actuation. Conventionally, a key of a typewriter or keyboard is dedicated to a 1:1 relationship between a finger contacting the individual key and an intended alphanumeric character assigned to the key. Rather, a keyless region as used for sensor input herein, senses one touch or multiple simultaneous touches (e.g., fingertip touches) corresponding to a select and limited set of ergonomically easy gestures, and the gestures do not have to be performed on specific, discrete keys as a keyboard would have. The select and limited set of ergonomically easy gestures is also designed to accommodate users with very long fingernails, a longstanding problem for communicating on small devices. The set of ergonomically easy gestures are programmable to alphabets, number, symbols, etc., and sets of navigation functions.

The touch-sensitive surface may be the touch screen display of a computer, tablet device, cell phone, or a touch-sensitive pad, for example. The finger touch patterns are based on approximately forty-four unique and ergonomically pleasing finger positions that can be performed or gestured on an area or subarea of a surface (hereinafter, “region”) that is approximately four finger widths wide and approximately three fingertip heights high. The ergonomically easy and pleasing finger positions are based on combinations of finger positions assumed while the hand or wrist is at rest and as if comfortably “tapping” with one or more fingers on a surface.

The finger touch patterns may constitute a set designed to be implemented by only one hand at a time (right-handed and left-handed implementations being mirror images of each other). The right-handed set does not need the left-handed set, and vice versa. Each set can function independently of the other, so that the user can communicate completely with only one hand. On the other hand, both right-handed and left-handed versions can be used with each other at the same time. Or, the finger touch patterns may also constitute a different set of patterns that can be implemented by splitting the set of symbols and functions between right and left hands, which must be used in harmony. The finger touch patterns can be programmed with different communication objects, e.g., with alphanumeric characters and functions. For example, each member of a set of touch patterns can be assigned with a letter of an alphabet, a number, a symbol, a word, a phrase, an image, a file operation, or a device navigation function.

In one implementation, an example system includes a database of stored touch patterns for communicating on a keyless region of an electronic input device, each stored touch pattern assigned an associated communication object. A sensor detects an input touch pattern on the keyless region. A differentiator then compares the sensed touch pattern with corresponding stored touch patterns in the database to recognize one of the stored touch patterns. Then, an interpreter collects each communication object associated with each recognized touch pattern. These may be passed, signaled, or transmitted to a device. Thus, the example system typically constitutes a user interface device.

The database of stored touch patterns can include a mix of single finger touch patterns and multiple finger touch patterns, each multiple finger touch pattern consisting of a configuration of multiple simultaneous finger touches on the keyless region. The database or the mix can thus be a set of touch patterns for communicating a complete alphabet and related functions with only one hand at a time, e.g., on a cell phone display, or can be a set of touch patterns for communicating with both right and left hands together on a larger touch screen display or pad, or on two smaller but separate devices that are communicatively coupled. In the one-handed implementation, right-handed and left-handed versions are each complete in themselves, and are a mirror image of each other. Each one-handed version is complete in itself, but that does not preclude it from being used with its mirror image version at the same time, i.e., right and left handed versions can be used together. There is also a two-handed version that splits the alphanumeric set between the two hands, so that both hands must be used in that version.

The keyless region may use various schemes to sense a given pattern. For example, in one implementation a keyless region is arranged in a limited number of sensing areas (for example, nine or ten) to detect a range of from approximately 26 to approximately 44 different touch patterns. But the sensing surface may use many other techniques for capturing a combination of simultaneous finger touches, such as stock touch sensing technology, imaging, photo, or optical sensing of multiple simultaneous touch contacts, etc.

The keyless region may be dynamically sized to a width dimension that dynamically approximates four finger widths of the user and a height dimension that dynamically approximates three finger thicknesses of an individual user. Since these physical dimensions of a user's fingers may vary, an example system can scale the keyless region to corresponding dimensions.

The database of touch patterns includes at least enough touch patterns and associated communication objects to compose a set of symbols or actions, such as an alphabet of a known language and associated symbols and functions. Thus, each communication object (e.g., alphanumeric character) assigned to a given individual touch pattern may be a letter of an alphabet, a number, a symbol, a word, a phrase, an image, a file operation, or a device navigation function. A digitizer may convert each communication object retrieved by the interpreter into a digital signal for transmission or input into a device.

### Example Environment

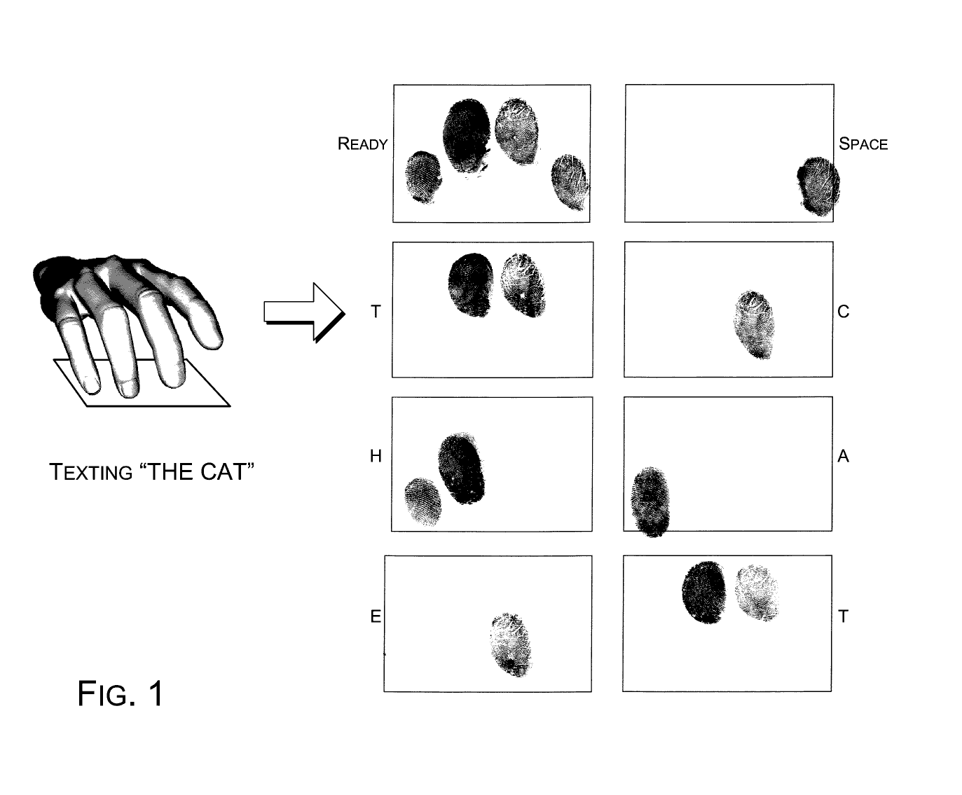

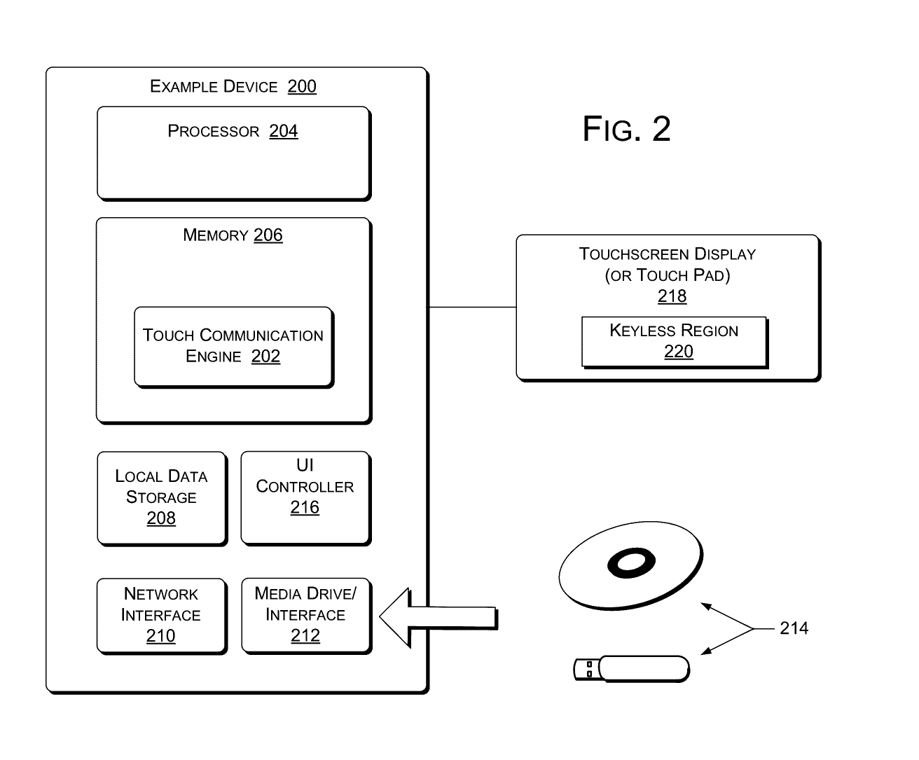

FIG. 2 shows the example texting scheme of FIG. 1 in the context and environment of an example cell phone, tablet, computing device, or electronic accessory, in which the touch alphabet can be performed.

An example device 200 shown in FIG. 1 includes or implements a component, such as the example touch communication engine 202 to enable input using the touch alphabet. The touch communication engine 202 is illustrated as software, but can be implemented as hardware or as a combination of hardware and software instructions.

The example device 200 typically has a processor 204, memory 206, data storage 208, and other associated hardware such as a network interface 210 and a media drive/interface 212 for reading a removable storage medium 214. The removable storage medium 214 may be, for example, a compact disk (CD); digital versatile disk/digital video disk (DVD); flash drive, etc.

The removable storage medium 214 may include instructions for implementing and executing the example touch communication engine 202. At least some parts of the example touch communication engine 202 can be stored as instructions on a given instance of the removable storage medium 214, a removable device, or in local data storage 208, to be loaded into memory 206 for execution by the processor 204.

A display and/or user interface (UI) controller 216 coordinates a touchscreen display 218 or other form of touch pad, which provides a means for sensing finger contacts for signaling or gesturing a touch alphabet. Touchscreen display 218 and the term “touch pad” are used interchangeably herein, with respect to their abilities to sense individual and touch finger contacts. The touchscreen display 218 may be located on the example device 200 itself, of may be remote to the example device 200. In one implementation, an example system generates a keyless region 220 on the touchscreen display 218 or touch pad for inputting touch patterns.

Although the illustrated example touch communication engine 202 is depicted as a program loaded into and residing in memory 206, a touch communication engine 202 may be implemented as hardware, such as an application specific integrated circuit (ASIC) or as hardware running software instructions.

The touch communication engine 202 associates input from the touch pad 218 with communication objects, such as characters and functions of a touch alphabet. The example device 200 may use the communication objects for its own touchscreen display 218 or another onboard display, or may send the communication objects to another device, for example, via the network interface 210.

The illustrated example device 200 in FIG. 1 shows components associated with using a touch alphabet. These components are not required to use a touch alphabet, they are shown to provide an illustrative environment. In another context, a sensing pad (i.e., computer accessory) connected to a conventional computer via USB port, for example, can also provide a complete context for practicing one of the touch alphabets described herein.

### Example Engine

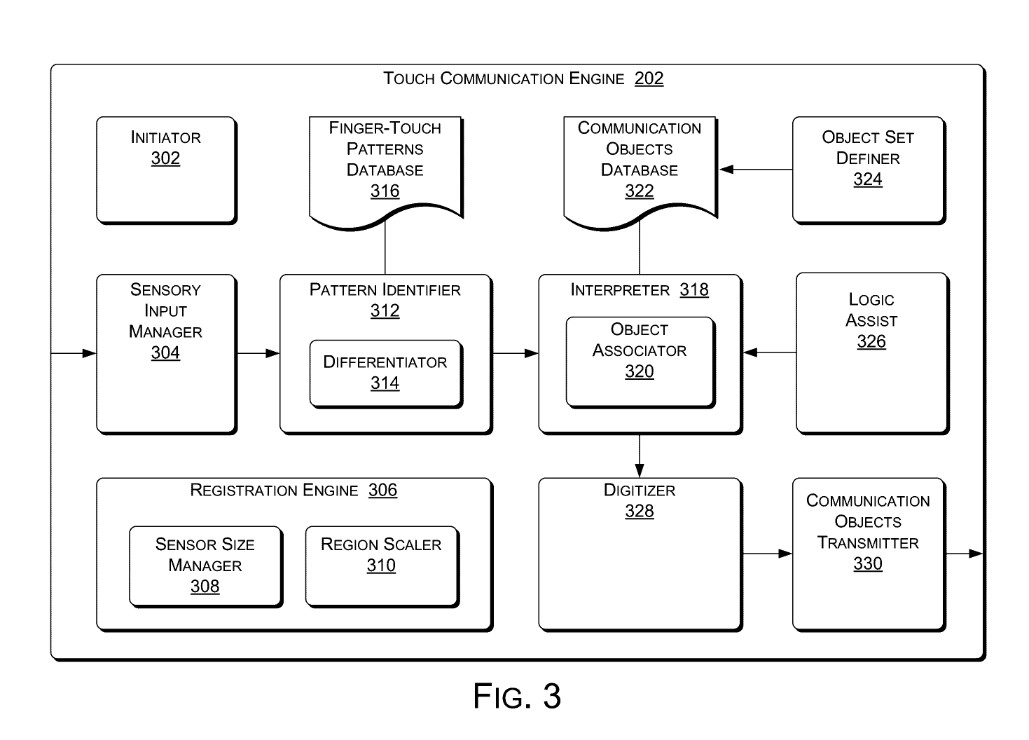

FIG. 3 shows an example touch communication engine 202 in greater detail than in FIG. 2. The illustrated implementation is only one example configuration for the sake of description, to introduce features and components of an engine that can use the example touch alphabets described herein. Thus, the illustrated components are only examples. Different configurations or combinations of components than those shown may be used to practice a touch alphabet. As introduced above, the example touch communication engine 202 can be implemented in hardware, or in combinations of hardware and software. Illustrated components are communicatively coupled with each other for communication as needed. Arrows are shown only to suggest process flow or data flow, since the components can communicate with each other as needed.

The illustrated touch communication engine 202 includes components for sensing and inputting finger contact information, for identifying finger touch patterns, and for associating the identified patterns with assigned communication objects, among others. A list of components in the illustrated example engine includes an initiator 302, a sensory input manager 304, a registration engine 306, a sensor size manager 308, a region scaler 310, a pattern identifier 312, a differentiator 314, a finger-touch patterns database 316, an interpreter 318, an object associator 320, a communication object database 322, an object set definer 324, a logic assist module 326, a digitizer 328, and a communication object transmitter 330.

Operation of the example flow visualization engine 104 will be described below.

### Operation of the Example Engine

Example systems, such as a system that uses the example touch communication engine 202 just described, implement a touch alphabet or a set of approximately forty-four unique and ergonomically pleasing fingertip contact gestures, touch codes, or “touch patterns.” The set of approximately forty-four touch patterns (per hand) are based on a concept that there are approximately forty-four ways that the four fingers of one hand can comfortably and ergonomically tap, alone or in combination, various touches on a region under the fingers, without appreciably moving the wrist or contorting fingers.

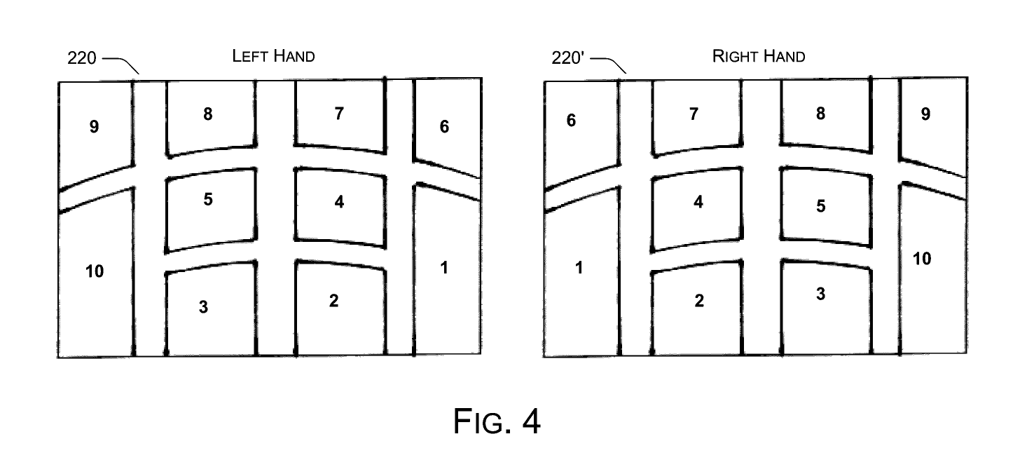

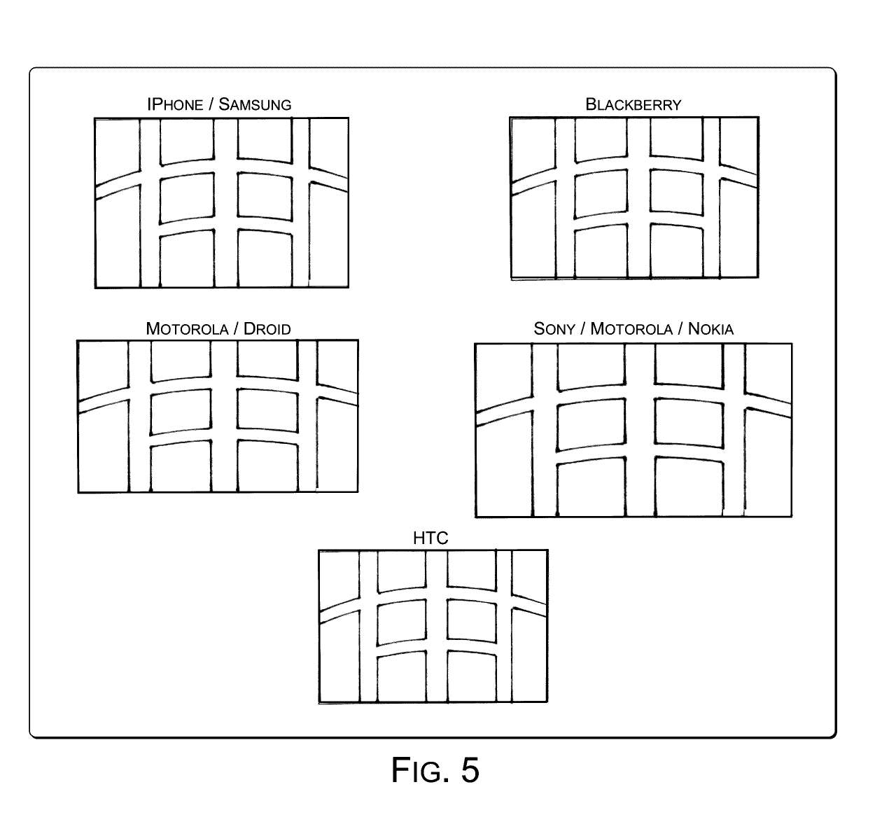

FIG. 4 shows one example scheme for sensing a set of touch patterns. A keyless region 220 is divided into approximately nine to ten sensor areas, as shown. These sensor areas are not visible to the user, but may be made visible for practice, e.g., on a practice pad. The illustrated sensor areas are not keys in a conventional sense, as many of the touch patterns sense a single individual finger on two sensor areas and as part of a large pattern of finger touch contacts with the keyless region 220. Right and left-hand versions of a keyless region 220 are shown. Only one of these versions is needed for a one-handed system, while both may be used with each other for a two-handed system. Either a right-handed or left-handed version of the example scheme can be implemented on many types of communication devices, as shown in FIG. 5. However, many other schemes could be used to capture the touch patterns of a touch alphabet besides the scheme shown in FIG. 4.

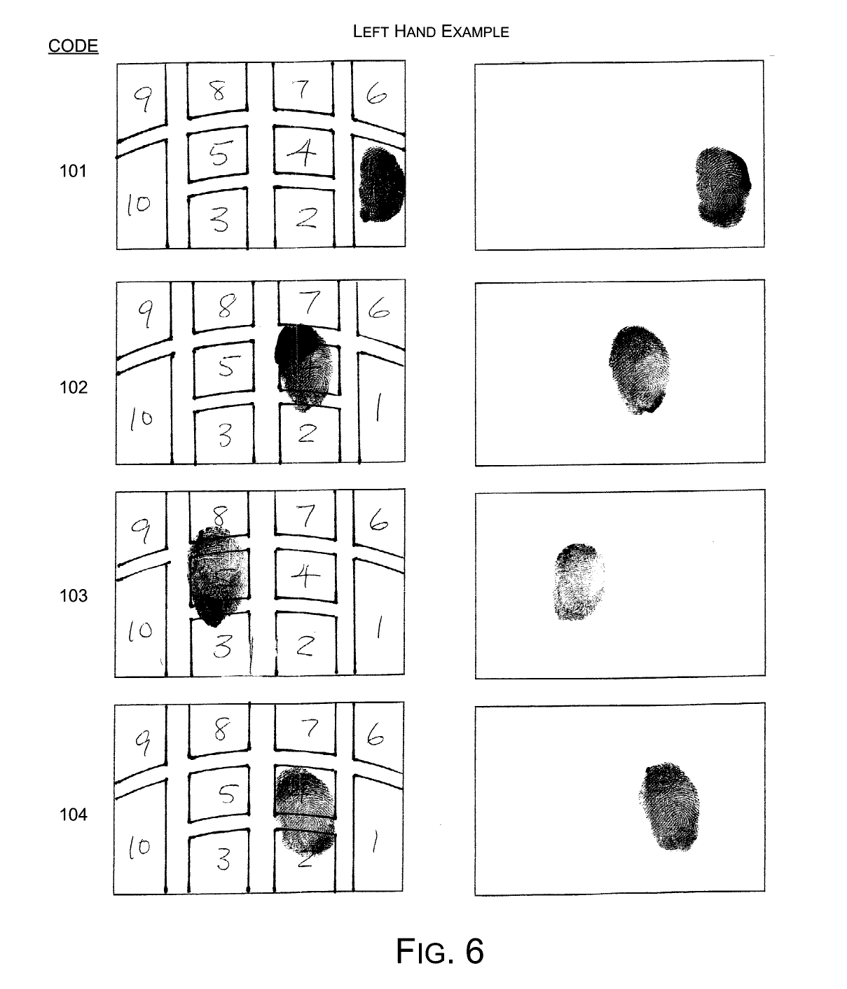

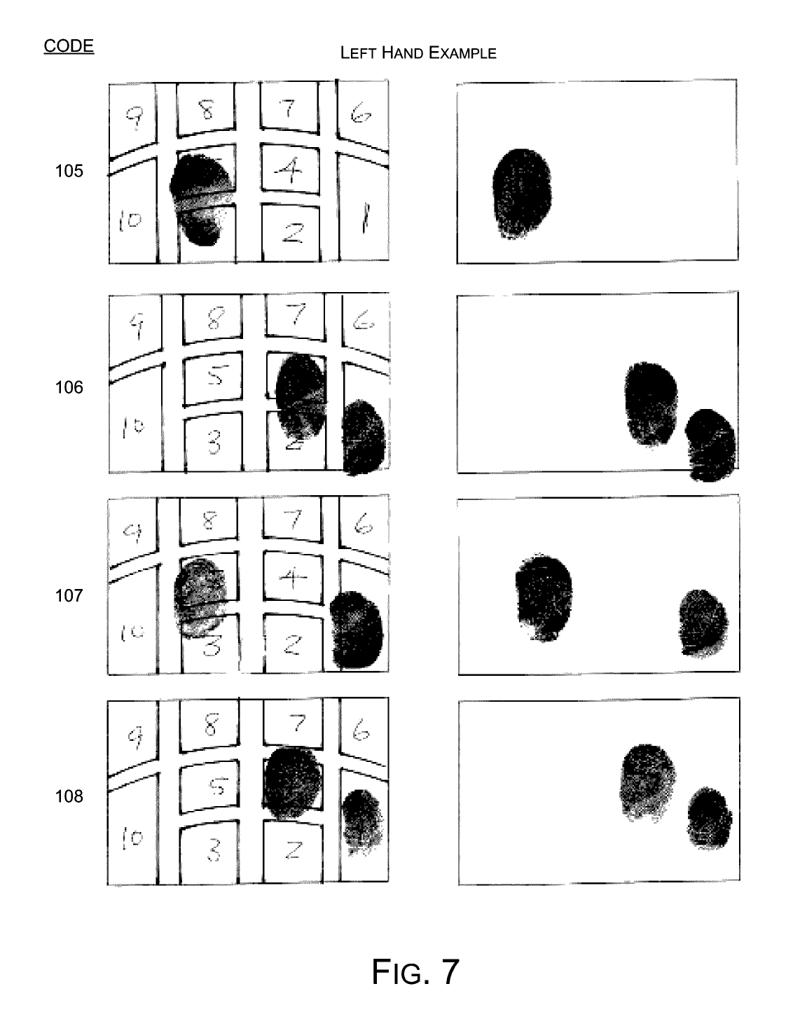

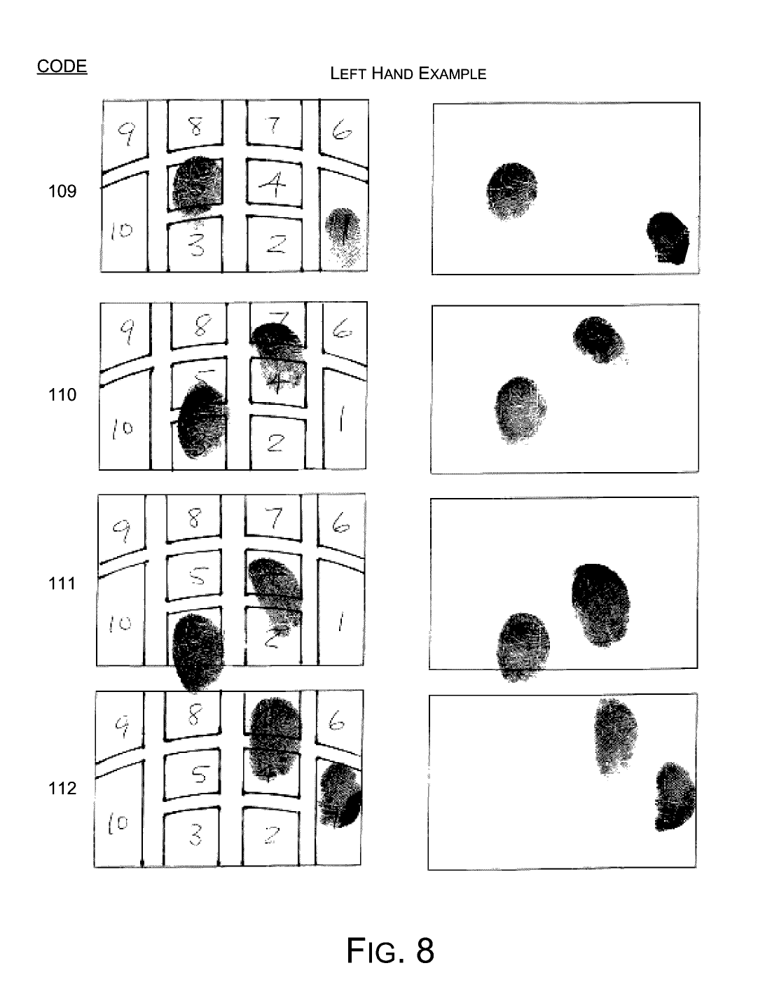

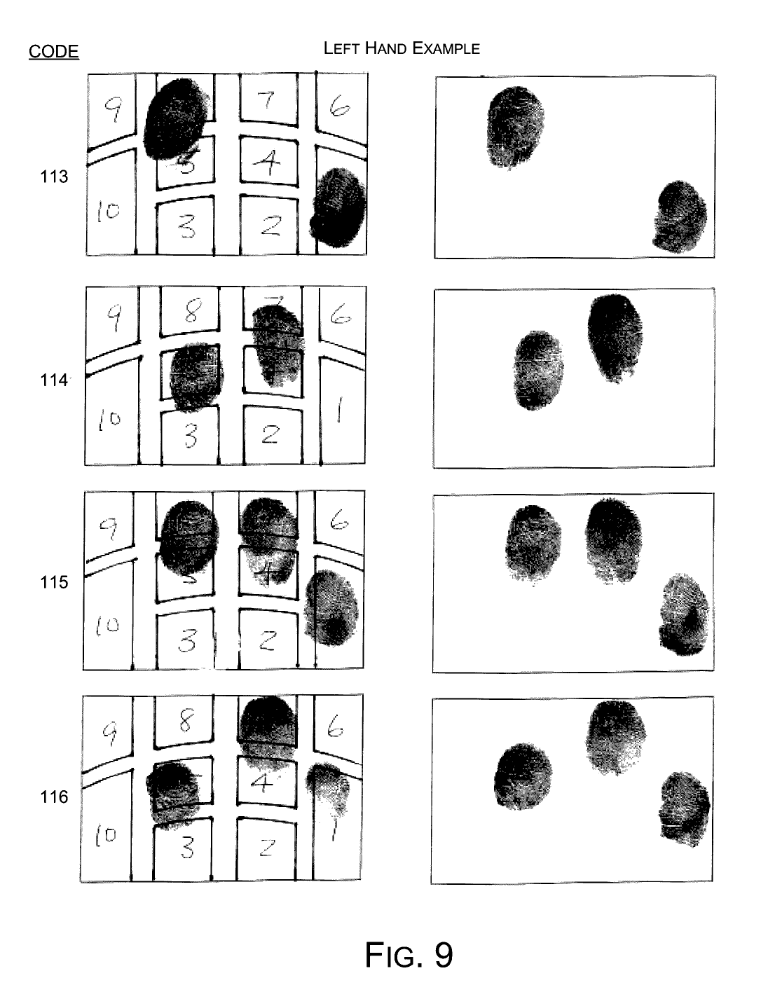

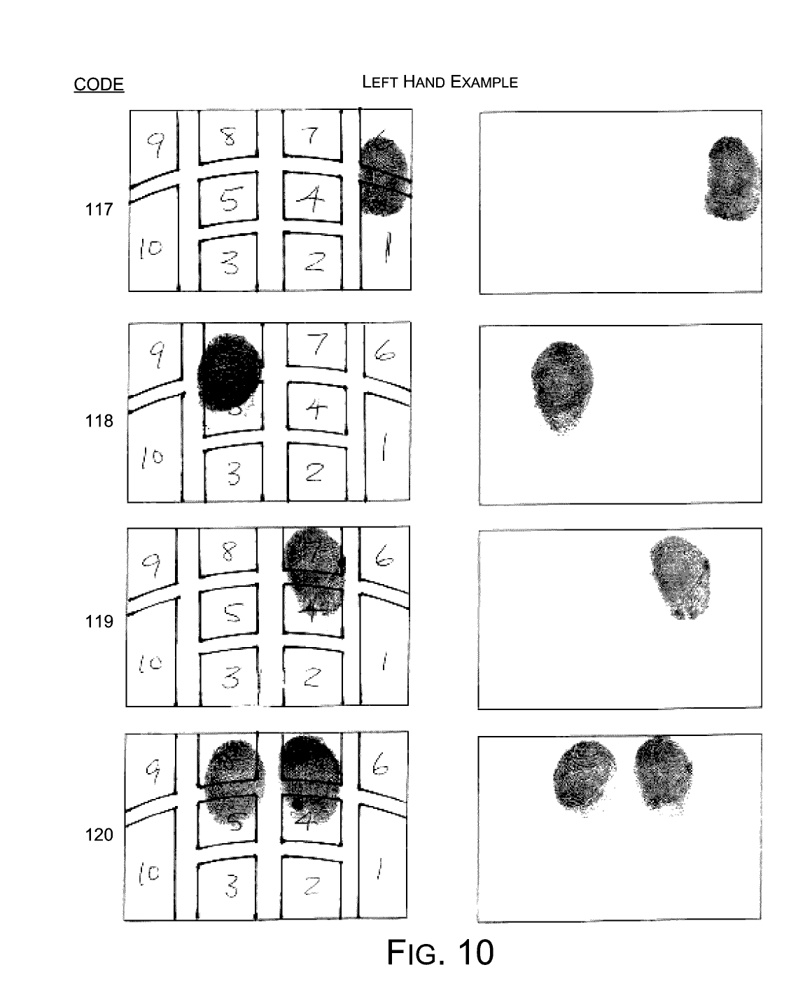

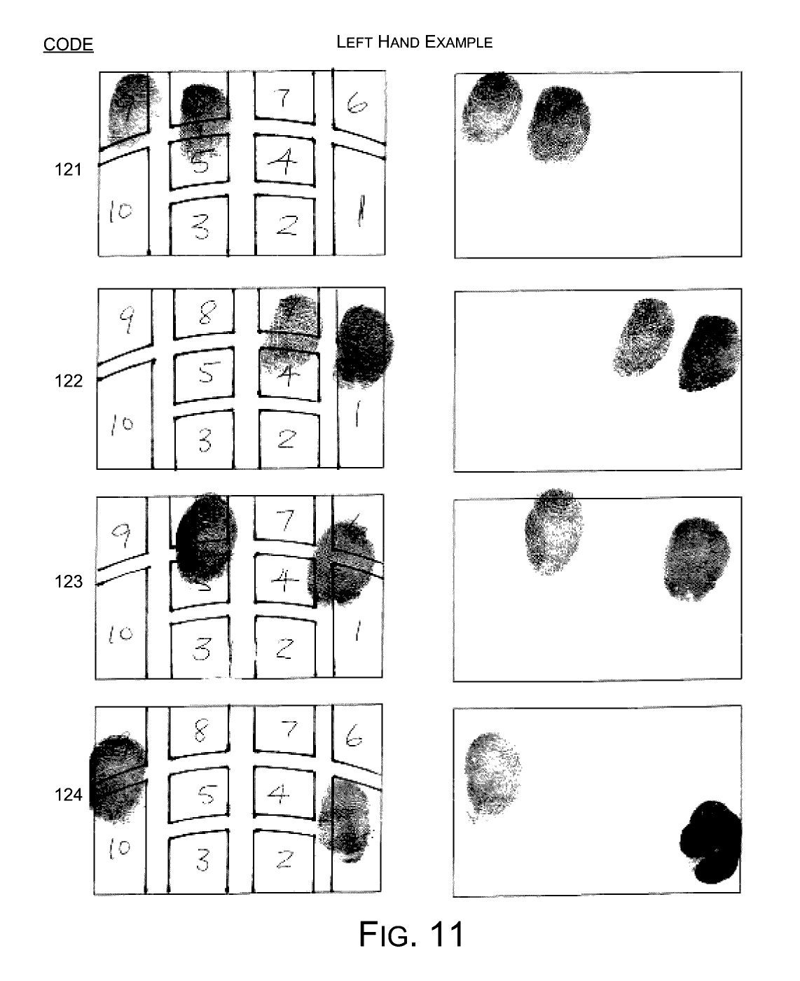

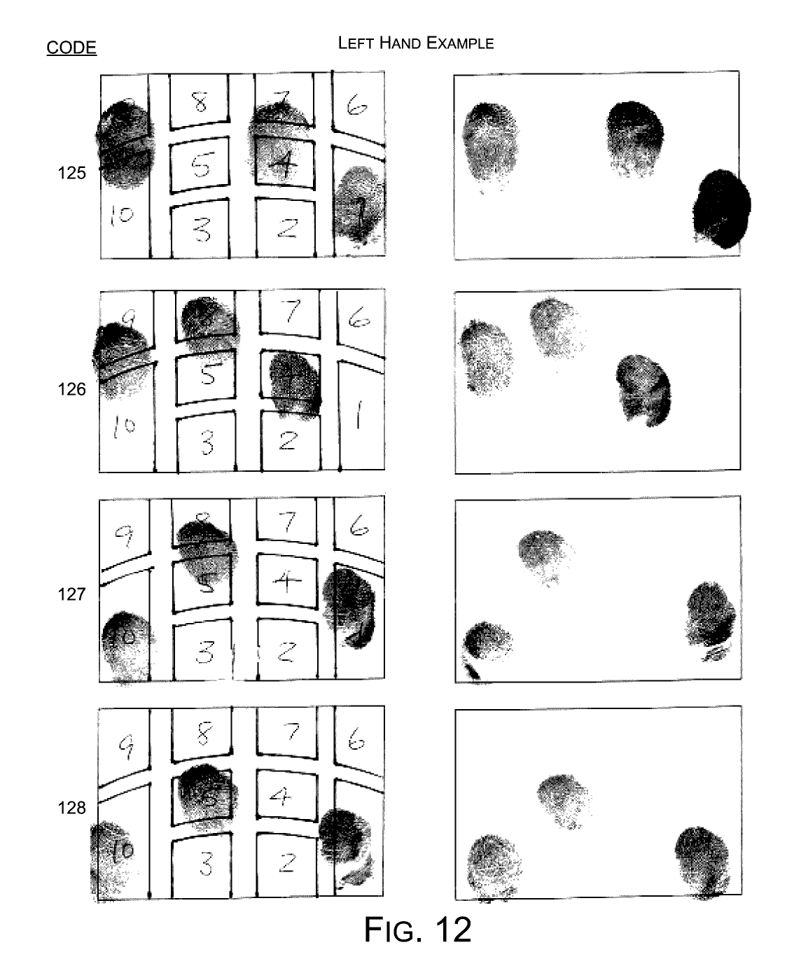

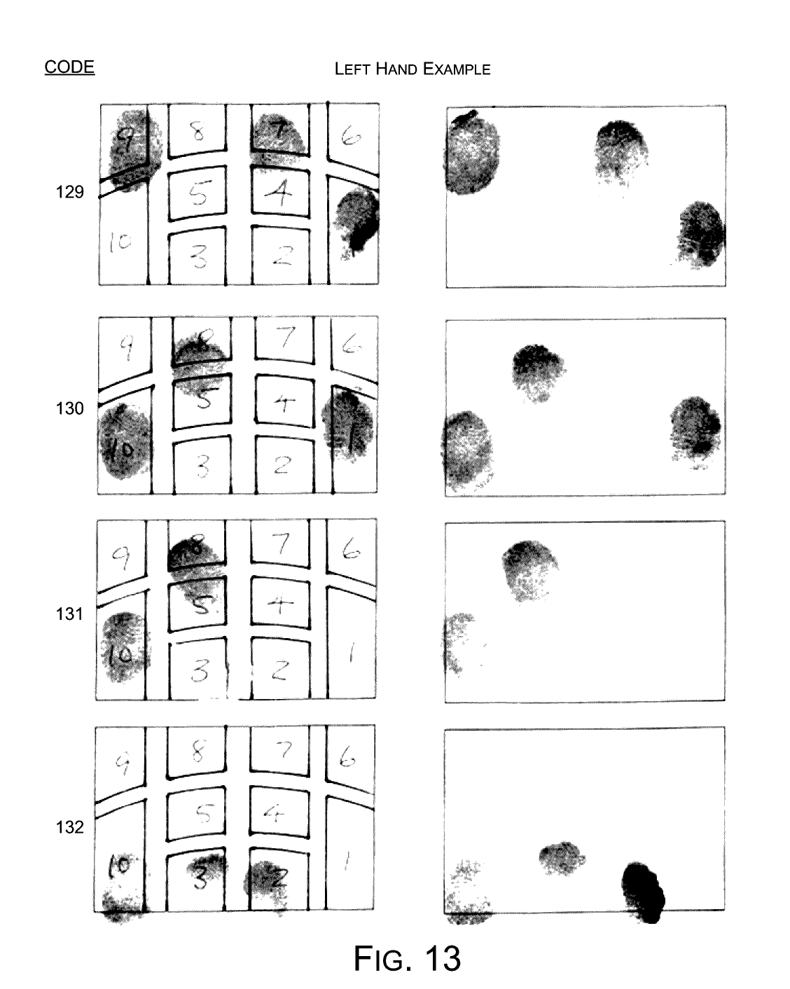

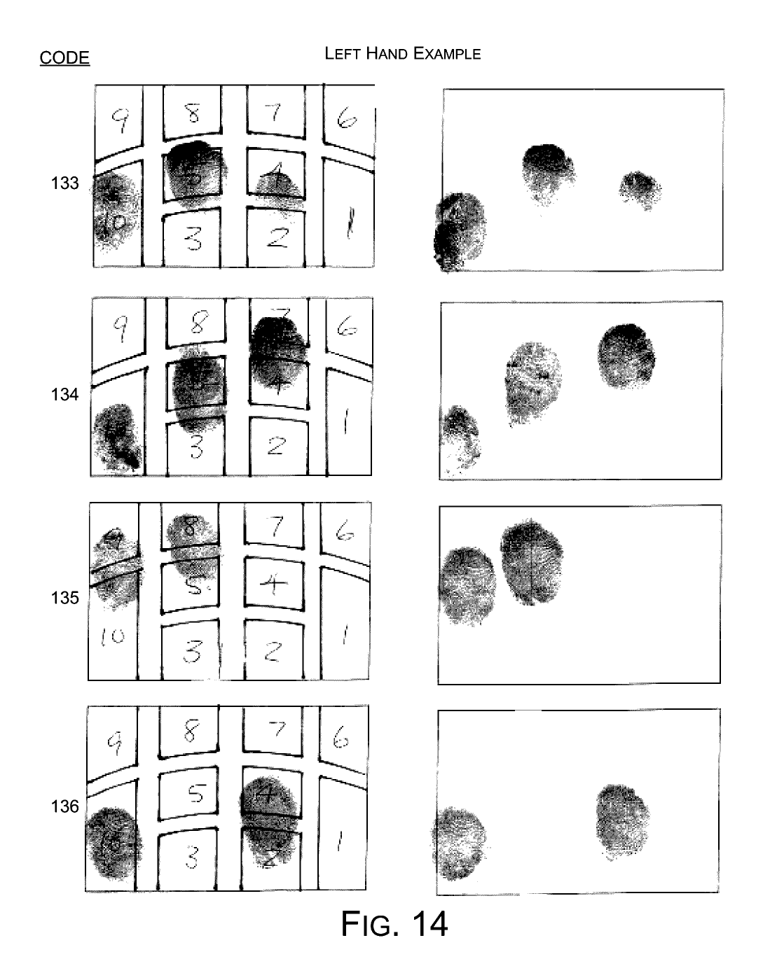

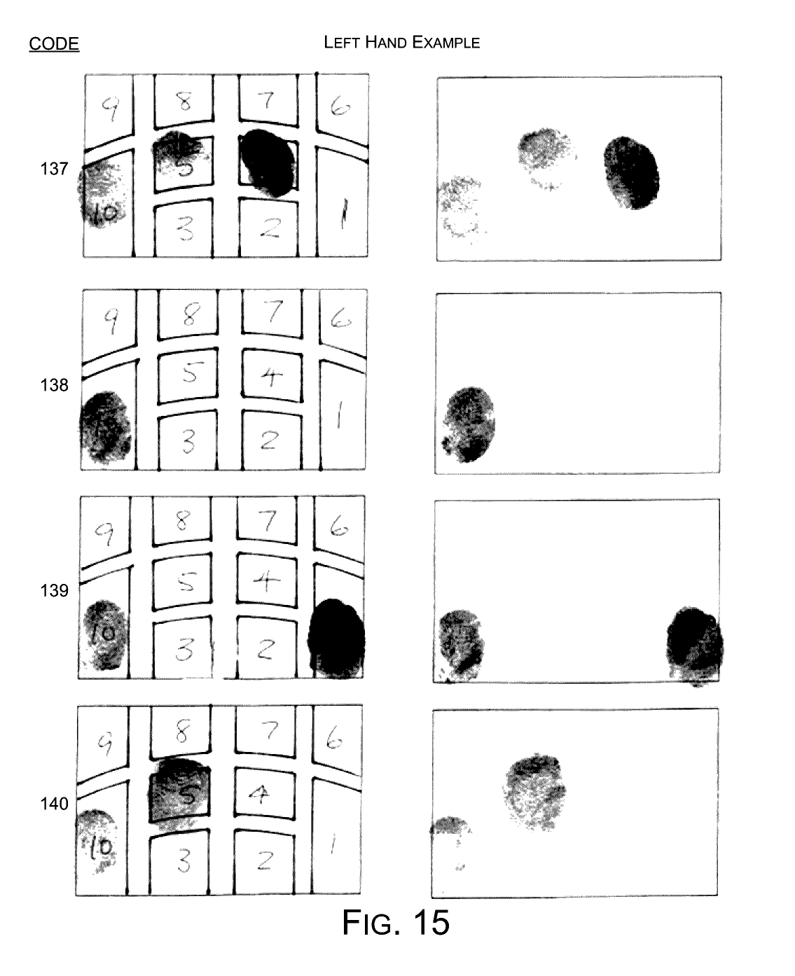

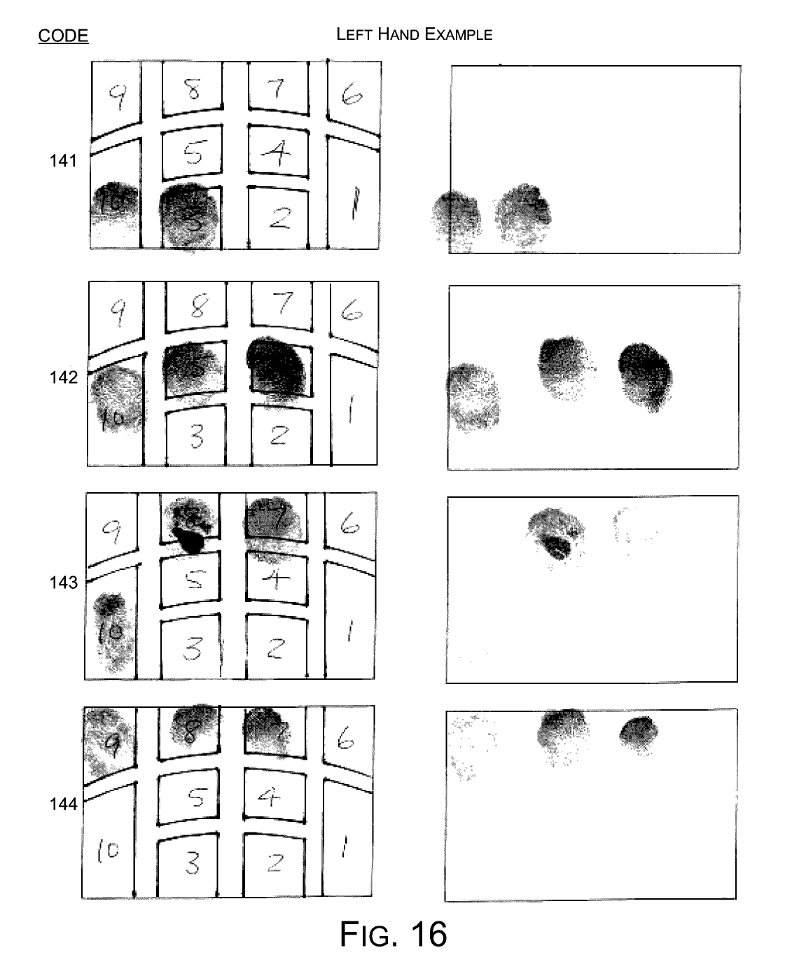

FIGS. 6-16 depict a set of approximately forty-four touch patterns that constitute an example “one-handed” finger-touch patterns database 316 (i.e., for the left hand) that can be used by the example touch communication engine 202. The scheme of dividing the keyless region into nine or ten sensor areas is also shown for reference. The forty-four touch patterns can then receive assignment of a selected alphabet, symbol set, and/or function set. Table (1), below, shows fingertip touches for each of the touch patterns in FIGS. 6-16 with reference to the example scheme of dividing the keyless region into sensor areas. The “/” mark in Table (1) indicates touching two sensor areas at the same time, e.g., “7/4” indicates touching pad 7 and pad 4 with the same fingertip at the same time, or alternatively, indicates touching in the area between two sensor areas in the example scheme for dividing the keyless region:

TABLE (1)

| | Sensor Areas |
|---|---|
| | Contacted by a |
| Pattern No. | Fingertip |
| 101 | 1 |
| 102 | 4 |
| 103 | 5 |
| 104 | 4/2 |
| 105 | 5/3 |
| 106 | 1 + 4/2 |
| 107 | 1 + 5/3 |
| 108 | 1 + 4 |
| 109 | 1 + 5 |
| 110 | 7/4 + 5/3 |
| 111 | 4/2 + 3 |
| 112 | 1 + 7/4 |
| 113 | 1 + 8/5 |
| 114 | 7/4 + 5 |
| 115 | 1 + 7/4 + 8/5 |
| 116 | 1 + 7/4 + 5 |
| 117 | 6/1 |
| 118 | 8/5 |
| 119 | 7/4 |
| 120 | 7/4 + 8/5 |
| 121 | 8/5 + 9 |
| 122 | 6/1 + 7/4 |
| 123 | 6/1 + 8/5 |
| 124 | 1 + 9/10 |
| 125 | 1 + 7/4 + 9/10 |
| 126 | 4 + 8/5 + 9/10 |
| 127 | 1 + 8/5 + 10 |
| 128 | 1 + 5 + 10 |
| 129 | 1 + 7/4 + 9 |
| 130 | 6/1 + 8/5 + 10 |
| 131 | 8/5 + 10 |
| 132 | 2 + 3 + 10 |
| 133 | 4/2 + 5 + 10 |
| 134 | 7/4 + 5 + 10 |
| 135 | 8/5 + 9/10 |
| 136 | 4/2 + 10 |
| 137 | 4 + 5 + 10 |
| 138 | 10 |
| 139 | 1 + 10 |
| 140 | 5 + 10 |
| 141 | 3 + 10 |
| 142 | 4 + 5 + 10 |
| 143 | 7 + 8 + 10 |
| 144 | 7 + 8 + 9 |

Table (2) shows an example assignment of alphanumeric characters and functions to the touch patterns:

TABLE (2)

| Letter or Function | Veroplay Touch Code No. |
|---|---|
| A | 101 |
| B | 102 |
| C | 103 |
| D | 104 |
| E | 105 |
| F | 106 |
| G | 107 |
| H | 108 |
| I | 109 |
| J | 110 |
| K | 111 |
| L | 112 |
| M | 113 |
| N | 114 |
| O | 115 |
| P | 116 |
| Q | 117 |
| R | 118 |
| S | 119 |
| T | 120 |
| U | 121 |
| V | 122 |
| W | 123 |
| X | 124 |
| Y | 125 |
| Z | 126 |
| Space | 138 |
| Return | 139 |
| Period | 140 |
| Comma | 141 |
| Question Mark | 140 twice |
| Exclamation | 141 twice |
| Capitalize Next Letter | 142 |
| Caps On | 142 twice (again = off) |
| Enter Numbers Function | 143 (again = off) |
| Choose Function 1-10 | 144 |

Table (3) shows another example assignment of alphanumeric characters and functions to the touch patterns:

TABLE (3)

| | | | | | | |
|---|---|---|---|---|---|---|
| Veorplay | Modern | Phoe- | | | | |
| Touch Code | Roman | nician | Arabic | Greek | Cyrillic | Etc. |

| | | | | | |
|---|---|---|---|---|---|
| 101 | A | aleph | A | APHA | A |
| 102 | B | beth | B | BETA | B |
| 103 | C | gimmel | T | GAMMA | V |
| 104 | D | daleth | TH | DELTA | G |
| 105 | E | he | J | EPSILON | D |
| 106 | F | waw | H | ZETA | E |
| 107 | G | zayin | KH | ETA | YO |
| 108 | H | heth | D | THETA | ZH |
| 109 | I | teth | DH | IOTA | Z |
| 110 | J | yodh | R | KAPPA | I |
| 111 | K | kaph | Z | LAMBDA | Y |
| 112 | L | lamedh | S | MU | K |
| 113 | M | mem | SH | NU | L |
| 114 | N | nun | S | XI | M |
| 115 | O | samekh | D | OMICRON | N |
| 116 | P | ′ayin | T | PI | O |
| 117 | Q | pe | TH | RHO | P |
| 118 | R | tsade | . | SIGMA | R |
| 119 | S | qoph | GH | TAU | S |
| ETC | | | | | |
| 144 | | | | | |

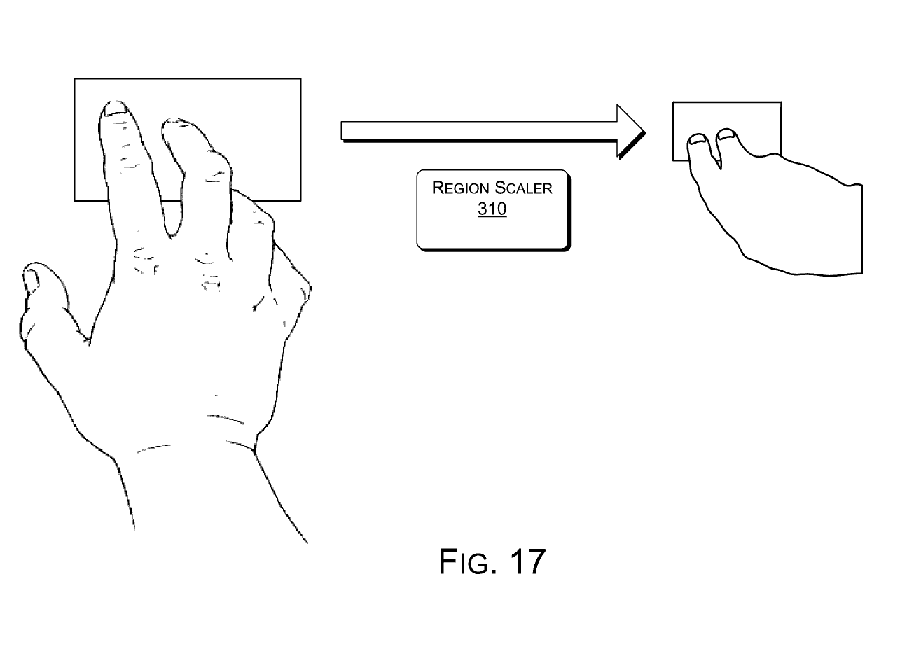

As shown in FIG. 17, the limited, keyless region 220 for multi-finger contact is scalable, and typically scaled to dimensions that can fit on a given cell phone or other small device. Thus, a user can comfortably tap an entire alphabet and related functions, with one hand, without having to visualize the user interface surface (i.e., without having to look at the touch surface and without having to hunt for individual keys as with conventional keypads and keyboards).

In one implementation, the region scaler 310 of the example touch communication engine 202 can scale two keyless regions, one for each hand, on a touch screen display of one device, or even across multiple devices, when the devices are in communication.

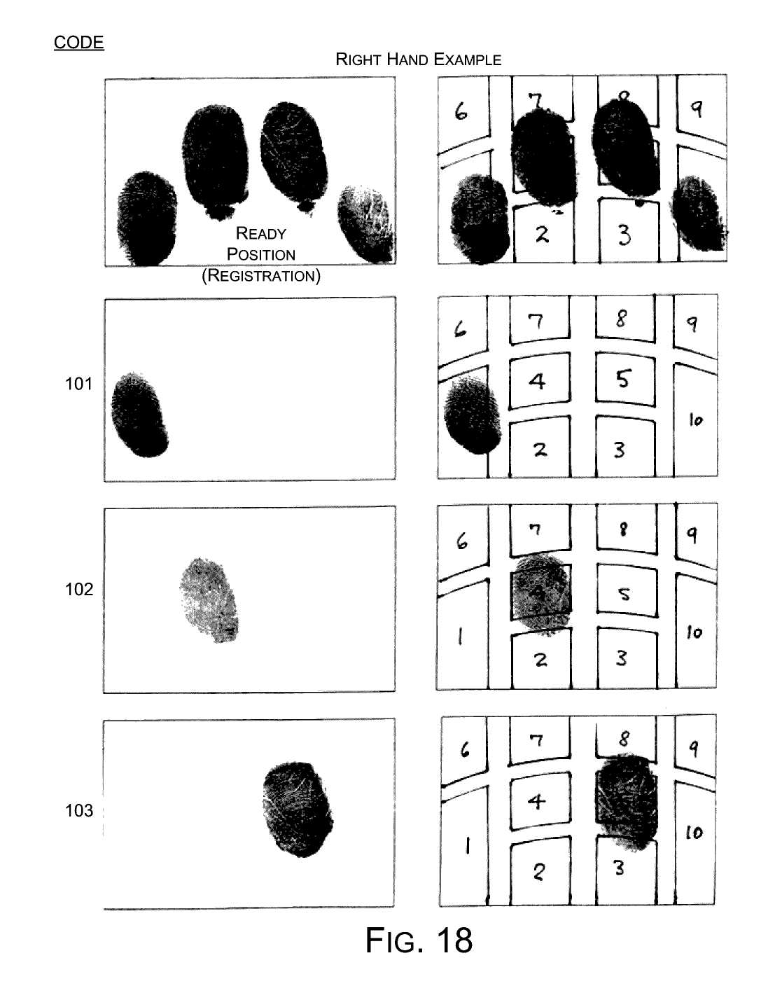

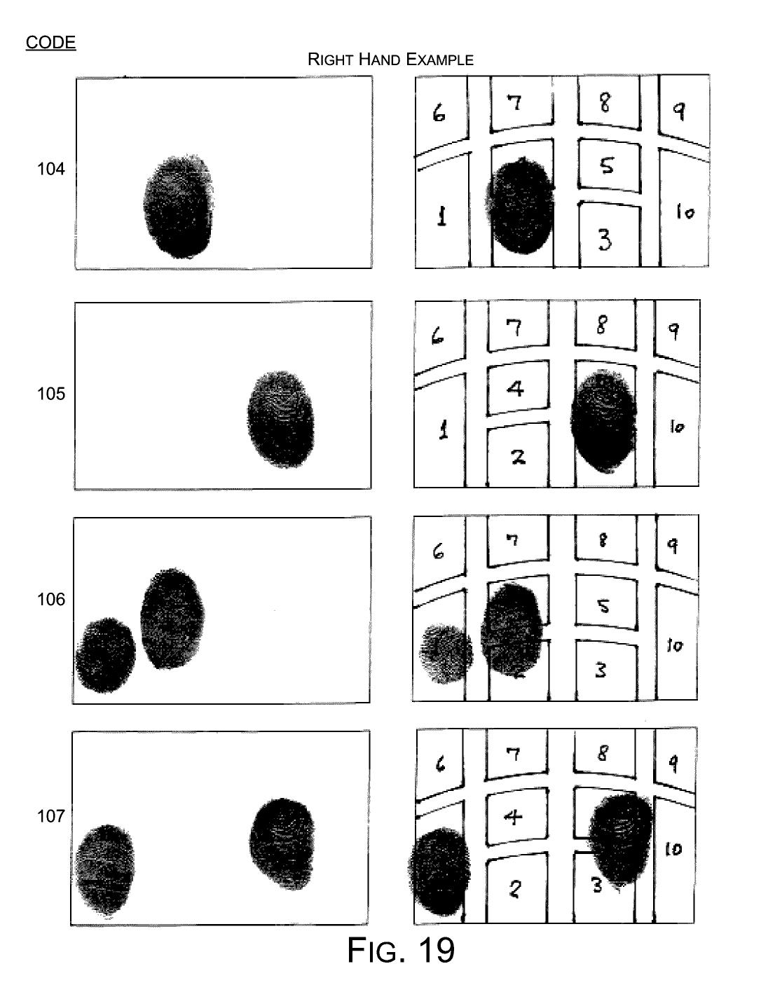

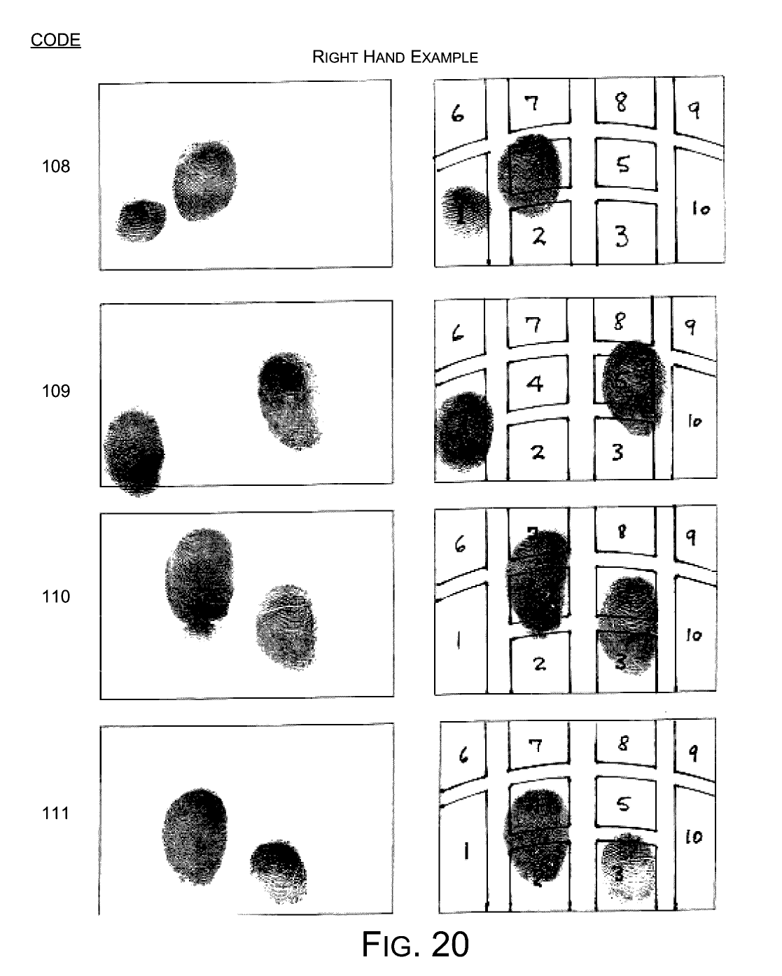

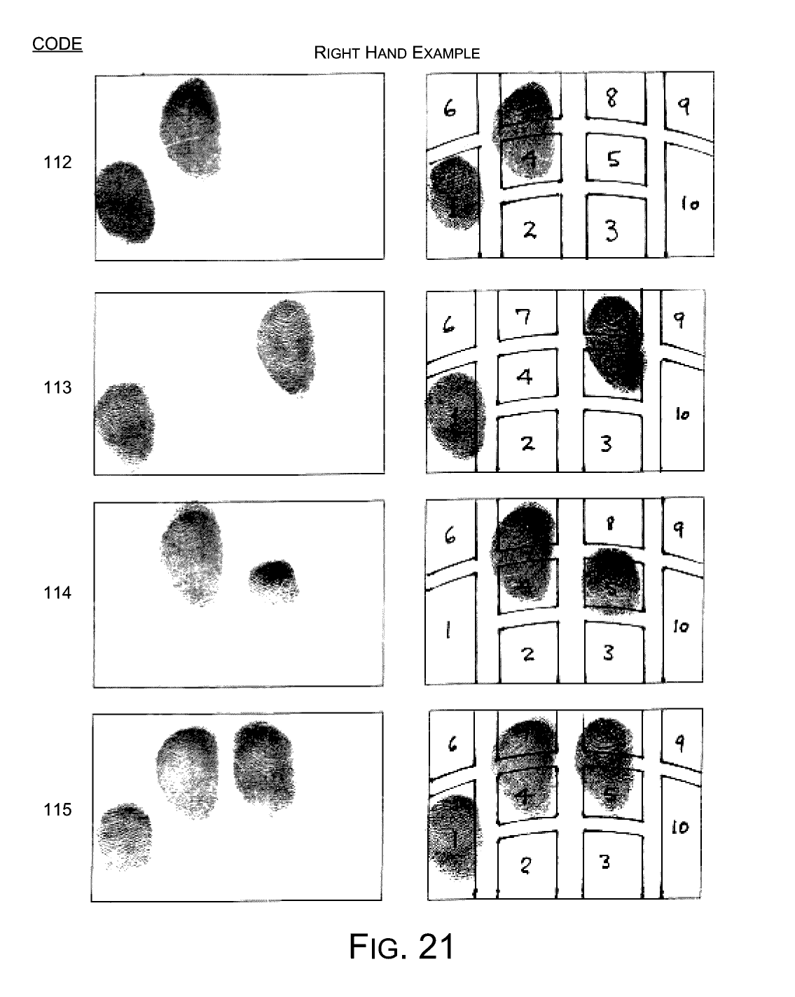

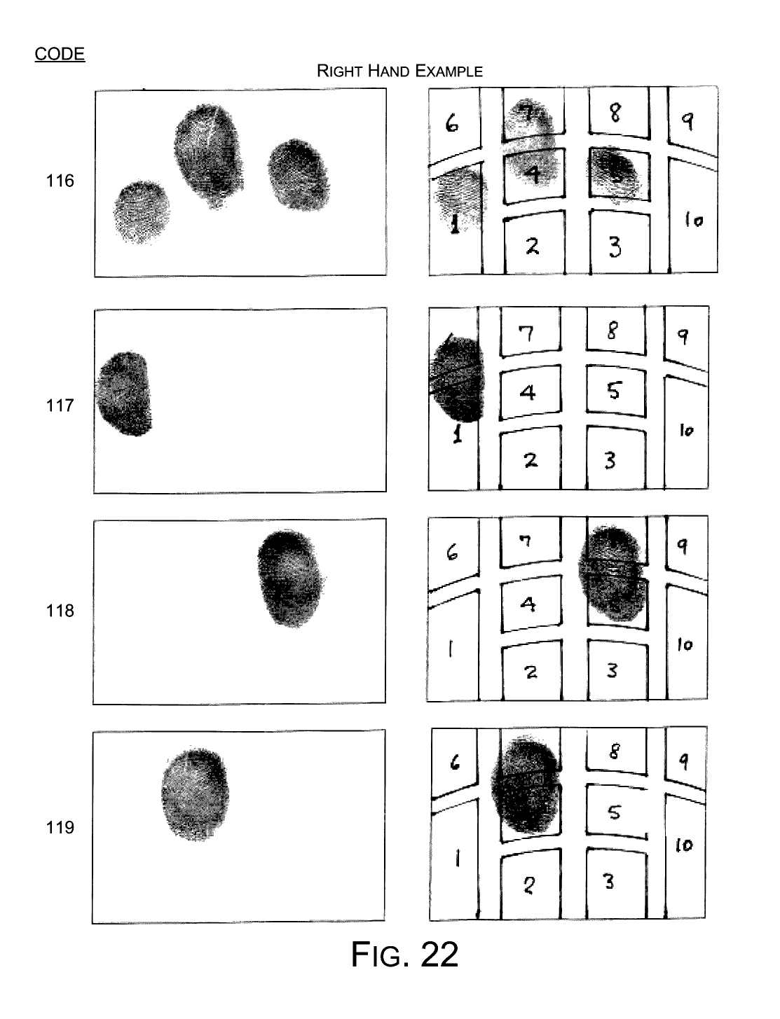

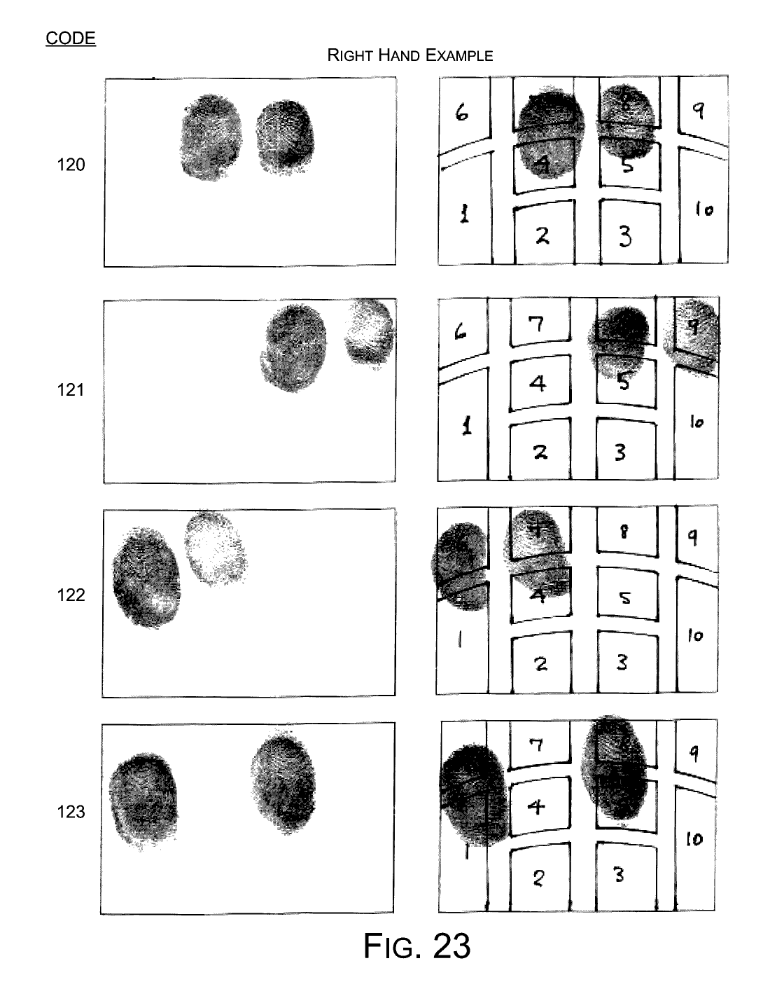

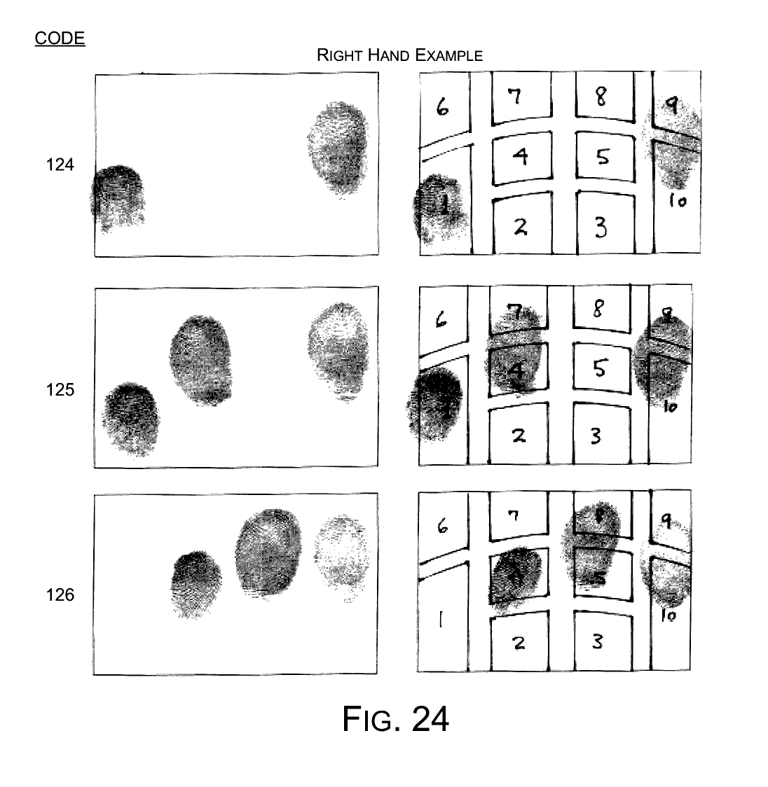

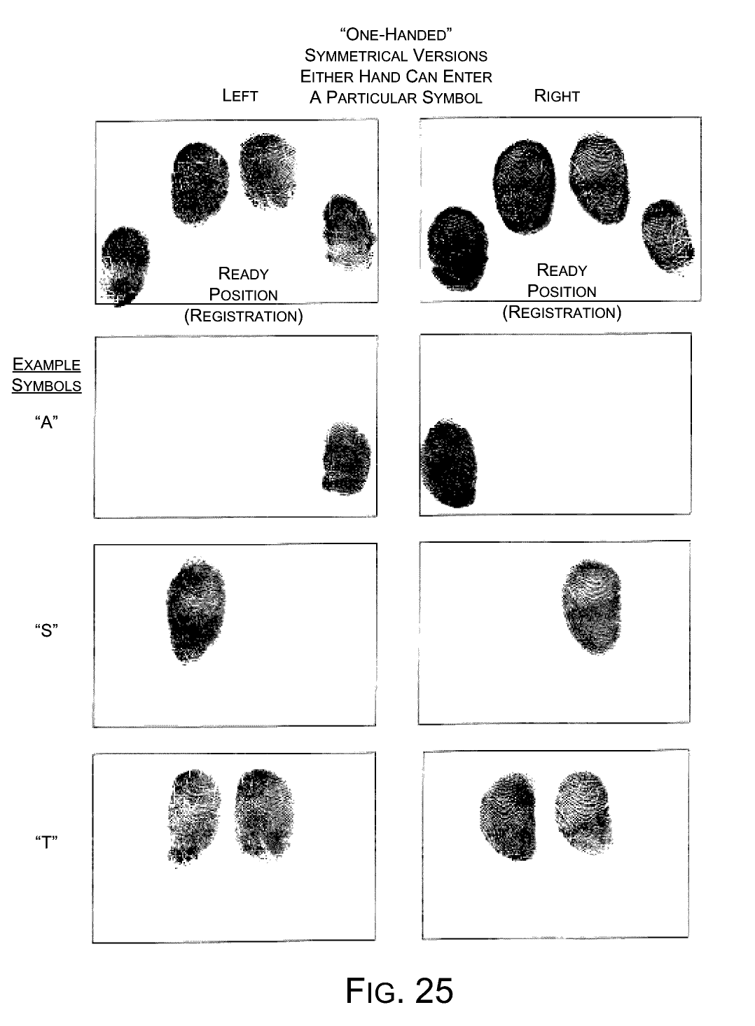

FIGS. 18-24 show another set of touch patterns that constitute an example finger-touch patterns database 316, for the right hand, that can be used by the example touch communication engine 202. As shown in FIG. 25, the set of touch patterns for the right hand shown in FIG. 18-24 is symmetrical to the set of touch patterns for the left hand shown in FIGS. 6-16. The scheme of dividing the keyless region into nine or ten sensor areas is also shown side-by-side for reference. This illustrated set of touch patterns (for the right hand, shown in FIGS. 18-24) has example alphanumeric characters and functions assigned to each individual touch pattern, as shown. The illustrated alphanumeric characters and functions are shown as a sample of programming the touch patterns 316.

The one-handed implementation can be performed on the relatively small window of most touch screen cell phones, and in addition, anywhere on larger screens, such as a portion of a tablet computer display.

An example two-handed system divides the target alphabet and functions between left and right hands.

Table (4), for example, shows an example assignment of touch patterns to alphanumeric characters and functions, divided between left and right hands:

TABLE (4)

| Letter or Function | Hand | Touch Pattern No. |
|---|---|---|
| A | right | 101 |
| B | left | 102 |
| C | left | 103 |
| D | left | 104 |
| E | right | 105 |
| F | left | 106 |
| G | right | 107 |
| H | left | 108 |
| I | right | 109 |
| J | left | 110 |
| K | left | 111 |
| L | left | 112 |
| M | left | 113 |
| N | left | 114 |
| O | right | 115 |
| P | left | 116 |
| Q | left | 117 |
| R | left | 118 |
| S | right | 119 |
| T | right | 120 |
| U | right | 121 |
| V | left | 122 |
| W | left | 123 |
| X | left | 124 |
| Y | right | 125 |
| Z | left | 126 |
| Space | either hand | 138 |
| Return | either hand | 139 |
| Period | right | 140 |
| Comma | right | 141 |
| Question Mark | left | 140 |
| Exclamation | left | 141 |
| Capitalize Next Letter | left | 142 |
| Caps On | right | 142 |
| Enter Numbers Function | right | 143 (again = off) |
| Choose Function 1-10 | right | 144 |

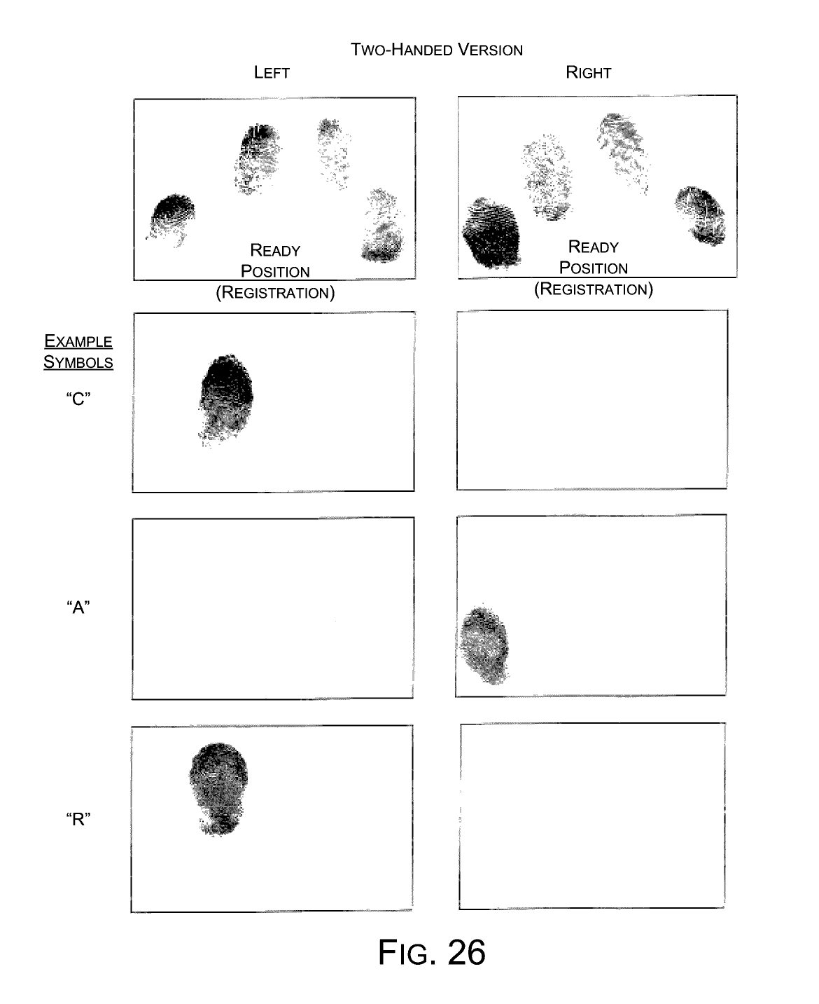

FIG. 26 shows an example texting of the example word “car,” using an implementation of the two-handed system described above. Four fingers of each hand register a keyless region for input for each hand. The left hand enters “C”, the right hand enters “A”, and the left hand enters “R”, and so forth.

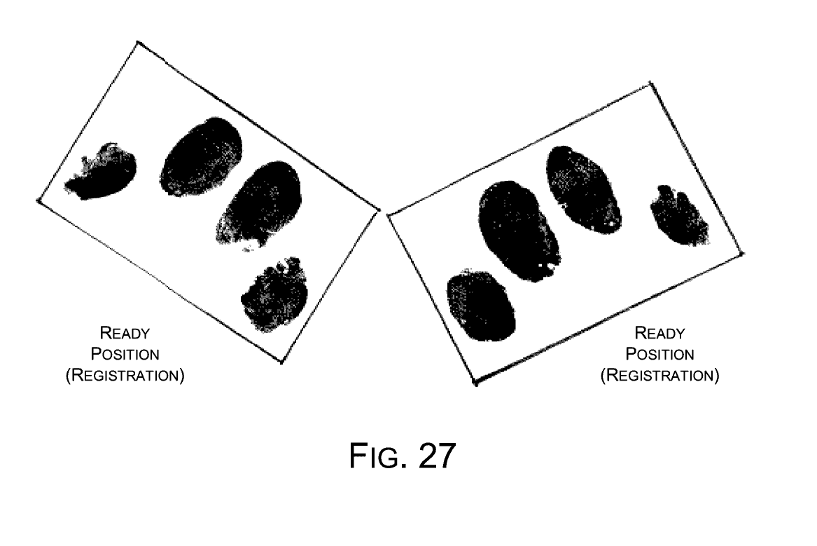

Returning to FIG. 3, which shows the example touch communication engine 202, the initiator 302, in conjunction with the sensory input manager 304, senses the presence of four adjacent fingertips contacting the surface of a touch screen display 218 or touch pad, and initiates further action by the example touch communication engine 202. The initiator 302 may signal the host device to switch data input of a user interface to the example touch communication engine 202. Once control of user input is handed over to the example touch communication engine 202, the registration engine 306 generates a keyless region on the touch screen display 218. The region scaler 310 generates a keyless region 220 with size dimensions appropriate for the size of the user's fingertips, and the sensor size manager 308 scales sensor schemes, if any, to the dimensions of the keyless region. FIG. 27 shows the registration engine 306 generating respective keyless regions 220 for a two-handed implementation of the system.

In one implementation, an example system defines the dimensions of a window, pane, or keyless region where the user will perform the communication gestures, based on the user casually placing four finger of one hand abreast on any part of the touch-sensitive display surface (e.g., outstretched fingers of either hand). For two-handed communication, the user can create two sensory input areas by placing four fingers of each hand to initiate keyless regions for input on one or more touch-sensitive display surfaces.

In one implementation, an initial four finger contact constitutes a registration that informs the example system that 1) the user wishes to communicate via the example touch alphabet; 2) “where” the user will be touch-communicating; and 3) whether the user will be communicating with the right, left, or both hands.

After the initial registration, the user can perform a series of the aforementioned finger touch patterns that represent the assigned letters, numbers, and/or desired functions in a selected alphanumeric scheme and function set.

The pattern identifier 312 includes a differentiator 314 that matches the sensory input (fingertips placements sensed) with the database of finger-touch patterns 316. The pattern identifier 312 may contain logic to interpret variations in fingertip placement and allow adjustment of the sense tolerances. For example, in one implementation, the pattern identifier 312 is configured to interpolate and identify each touch code or gesture by its:

1) relative position to the initial four finger registration;

2) relative position of the fingers used in each touch;

3) relative position of the current touch to the last touch; and if needed:

4) the relative position of the current touch to the NEXT touch; and also:

5) these four combined with higher spelling and grammar logic, automatic spell correction, etc.

When a touch pattern is identified, then the interpreter 318 includes an object associator 320 to match the sensed touch pattern with an assigned symbol or function from the communication objects database 322 (e.g., a letter of the alphabet or navigation function). This assignment of a communication object may be guided by a logic assist module 326 that applies known spell-check and grammar rules to discern what the operator meant to type or text.

An object definer 324 allows a user or manufacturer to preprogram the communication objects to be associated with touch patterns, for example, letters of an alphabet, numbers, symbols, words, phrases, images, file operations, or device navigation functions may all be associated with a touch pattern.

A digitizer 328 may be used to convert the communication object to a data signal representing user input appropriate for the particular device. Likewise, a communication objects transmitter 330 may send the communication objects to a particular device, especially when the example touch communication engine 202 is used in a device that is mainly or exclusively a user input device (e.g., standalone touch pad).

### Example Methods

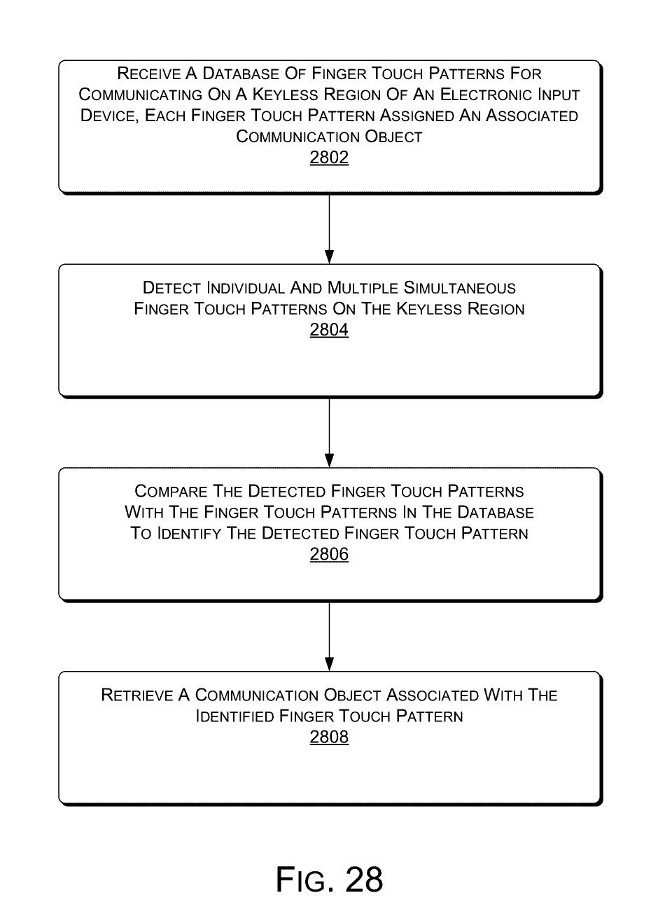

FIG. 28 is an example method 2800 of utilizing a touch alphabet. In the flow diagram, the operations are summarized in individual blocks. The example method 2800 may be performed by hardware or combinations of hardware and software, for example, by the example touch communication engine 202.

At block 2802, a database of fingertip touch patterns is received for communicating on a keyless region of an electronic input device. Each fingertip touch pattern is assigned an associated communication object.

At block 2804, individual and multiple simultaneous fingertip touch patterns are detected on the keyless region.

At block 2806, the detected fingertip touch patterns are compared with the fingertip touch patterns in the database to identify the detected touch pattern.

At block 2808, a communication object associated with the identified fingertip touch pattern is retrieved.

### Example Implementations

In an implementation, an example system employs a touchscreen 218 capable of sensing multiple simultaneous finger contacts. An area 220 of the touchscreen 218 can be assigned for sensing the multiple simultaneous finger contacts, and the area 220 may be configured in real time to approximate a width of four fingers of one hand of the current user.

A database of touch patterns 316 has a character of an alphabet assigned to each touch pattern, so that the database 316 is an alphabet of touch patterns. In an implementation, the database of touch patterns 316 includes three types of touch patterns, for example:
touch patterns composed of one single finger contact sensed on the designated sensing area at a position in the area indicative of one of the four fingers, the finger in a given degree of extension that is relevant for forming one of the touch patterns;
touch patterns composed of two simultaneous finger contacts sensed on the area and indicative of two of the four fingers in a given configuration relevant for forming one of the touch patterns; and
touch patterns composed of three simultaneous finger contacts sensed on the area and indicative of three of the four fingers in a given configuration relevant for forming one of the touch patterns.

In an implementation, the pattern identifier 312 and interpreter 318 identify the sensed touch pattern, based on knowledge of the database of touch patterns 316, and associate a digital signal representing the assigned character of the alphabet with each touch pattern sensed by the designated area 220 of the touchscreen 218.

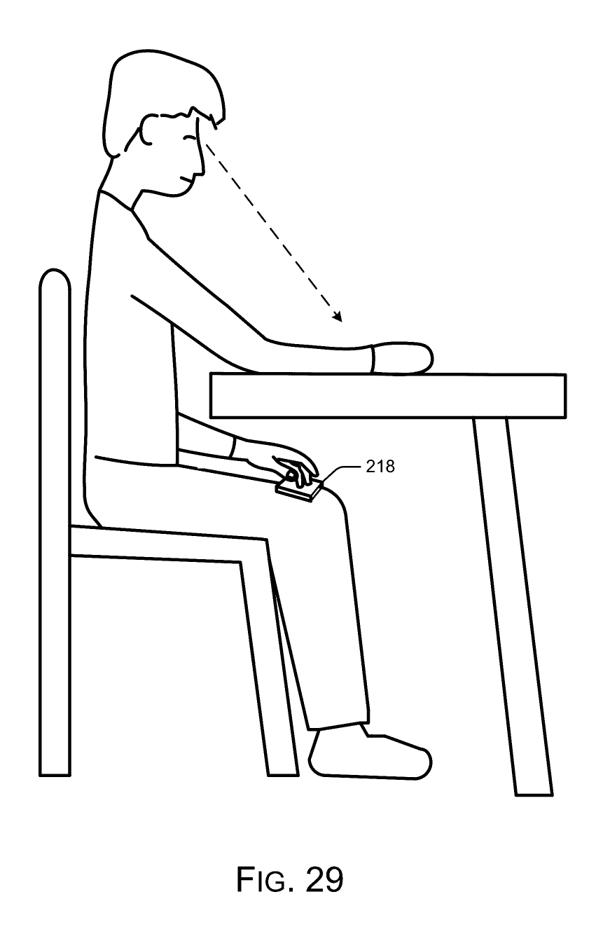

FIG. 29 shows a user texting with one hand, without looking at the touchscreen 218 of the input device for sensing finger touch contacts of the touch pattern alphabet. All of the characters of the alphabet or the database of touch patterns 316 are formable on the sensing area 200 of the touchscreen 218 by the fingers of one hand of the current user. Thus, the database of touch patterns 316 enables the current user to communicate an entire alphabet with one hand using the alphabet of touch patterns, and without the current user having to view (visualize) the touchscreen 218 or area 220 assigned for sensing the multiple simultaneous finger contacts. This is because the touch patterns are composed of finger positions (configurations) relative to the user's hand, not finger positions relative to individual sensing keys on an input device, such as the keys of a QWERTY input scheme. No defined keys are needed for the user to text the touch pattern alphabet on the touchscreen 218, and so the user does not have to see the touchscreen 218 in order to find keys to contact.

In an implementation, the registration engine 306 of the example system designates the area 220 of the touchscreen 218 for input of the touch patterns. The designated area 220 may have a length approximating four adjacent simultaneous finger contacts of the four fingers of one hand of the current user, and a width approximately two-thirds of the length.

The region scaler 310 may sense a size of a touch contact or a size of multiple touch contacts on the area 220 of the touchscreen 218 and scale the area 220 based on the size of the touch contact or the size of the multiple touch contacts. In an implementation, the initiator 302 may sense four adjacent simultaneous finger contacts on the touchscreen 218 to signal the host device to switch general data input of the touchscreen 218 to sensing the touch patterns representing the alphabet, for example in a designated area 220 of the touchscreen 218.

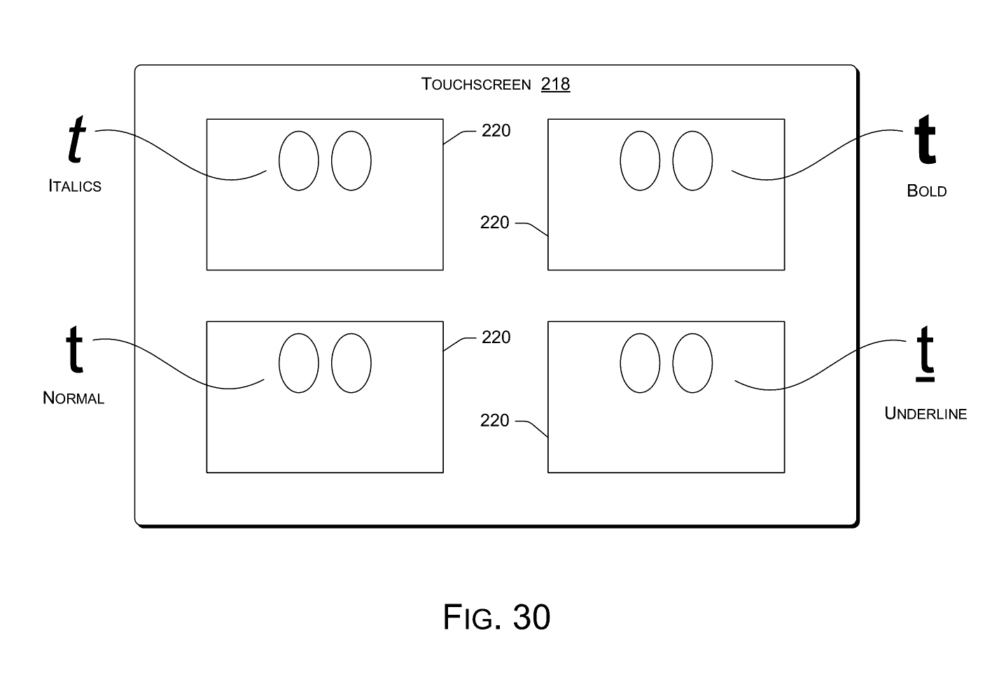

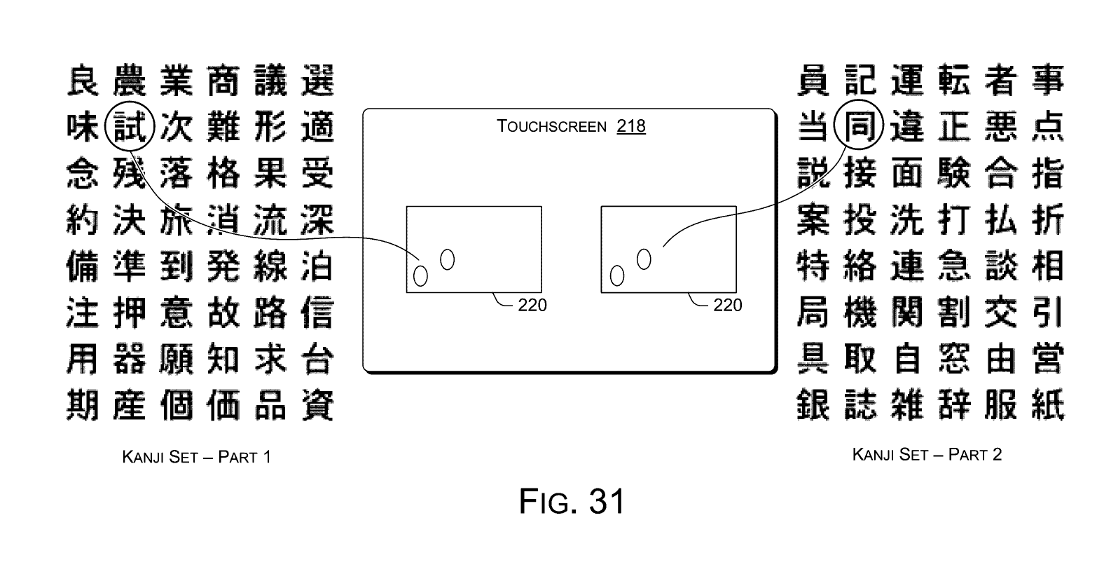

As shown in FIG. 30 (and in FIG. 31), an example system may create multiple instances of the area 220 for sensing the touch patterns, each in a different location on a single touchscreen surface 218. Each different instance of the area 220 for sensing the touch patterns signals may result in the system adding a different typographical emphasis to an assigned character of the touch pattern sensed by the respective area 220, for example by signaling the pattern identifier 312 and interpreter 318 to add the particular emphasis or characteristic. For the same texted letter “t”, for example, a given instance of the area 220 for sensing the touch patterns may add a typographical emphasis such as capitalization, underline, italics, bold, a font style variation, a font size variation, subscript, superscript, and so forth.

As shown in FIG. 31, in another implementation, the example system may divide input of a given alphabet among the multiple instances of the area 220 for sensing the touch patterns. This is especially useful for large alphabets used in various parts of the world. The database of touch patterns 316 for the given alphabet may be divided among the multiple instances of the area 220 for sensing. Each different instance of the area 220 assigns a different part of the alphabet to touch patterns sensed in the respective instance of the area 220. This may mean that each instance of the area 220 for sensing the touch patterns senses a same set of the touch patterns, but assigns characters from a respective different part of the alphabet to the touch patterns sensed in the respective instance of the area 220 for sensing.

The characters of a given alphabet may be composed of alphanumerics, alphabet characters, alphabet letters, numbers, glyphs, segments, scripts, graphic characters, calligraphies, symbols, and so forth.

A given alphabet to be represented by the touch patterns may be associated with a language, such as Khmer (Cambodian), Devanagari, Sanskrit, Vedic Sanskrit, Persian, Kabardian, Abkhaz, Cyrillic, Slovak, Chinese, Spanish, Arabic, Georgian, Japanese, Japanese Hiragana, English, Russian, Korean, Hawaiian, Azeri, Italian, Malayalam, Armenian, Albanian, Mandarin, Latin, Han, and Greek, for example.

An example method assigns an area of a touchscreen for sensing multiple simultaneous finger contacts, for example, configuring the area in real time to approximate a width of four fingers of one hand of a current user. A database of touch patterns is stored, with each touch pattern assigned a character of an alphabet, so that the database is composed of an alphabet of touch patterns.

In an implementation, the database of touch patterns may include three types of touch patterns, such as touch patterns composed of one single finger contact sensed on the touchscreen at a position on the touchscreen indicative of one of the four fingers in a given degree of extension, touch patterns composed of two simultaneous finger contacts sensed on the touchscreen indicative of two of the four fingers in a given configuration, and touch patterns composed of three simultaneous finger contacts sensed on the touchscreen indicative of three of the four fingers in a given configuration. The method associates a digital signal representing the assigned character of the alphabet with each touch pattern sensed by the touchscreen.

All the characters of the alphabet of touch patterns may be formable by the fingers of one hand of the user. Thus, the user may be enabled to communicate the entire alphabet with one hand using the alphabet of touch patterns, without the current user having to visualize the touchscreen, while the touchscreen is sensing the multiple simultaneous finger contacts.

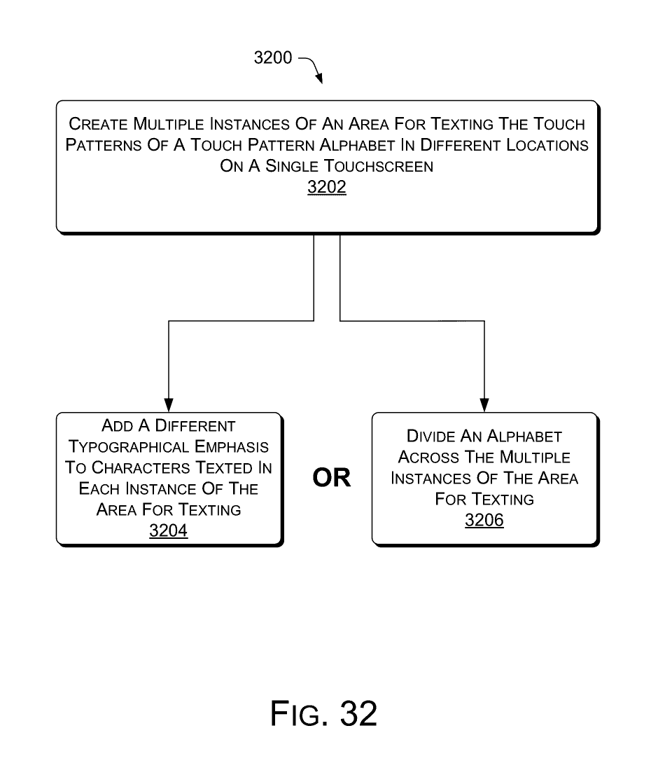

As shown in FIG. 32, an example method 3200 may include creating multiple instances 3202 of the area for sensing the touch patterns in different locations on a single touchscreen. Each different instance of the area for sensing the touch patterns may be configured, or employed to add a typographical emphasis 3204 to an assigned character of a touch pattern sensed by that respective area. For example, a given instance of a touchscreen area for sensing the touch patterns may add a typographical emphasis, such as capitalization, underline, italics, bold, a font style variation, a font size variation, subscript, superscript, and the like.

The example method may also divide a given alphabet (3206) among the multiple instances of the area for sensing the touch patterns. That is, input of the characters of the selected alphabet may be divided among the multiple instances of the area for sensing. Each different instance of the area assigns a different part of the alphabet of characters to the touch patterns sensed in the respective instance of the area. Each character of the alphabet may be an alphanumeric, an alphabet character, a letter, a number, a glyph, a segment, a script, a graphic character, a calligraphy, a symbol, and so forth. So, in an implementation, each instance of the area for sensing the touch patterns may sense a same set of the touch patterns but assigns characters from a respective different part of the alphabet to the touch patterns sensed in the respective instance of the area for sensing.

### CONCLUSION

Although exemplary systems and methods have been described in language specific to structural features and/or methodological acts, it is to be understood that the subject matter defined in the appended claims is not necessarily limited to the specific features or acts described. Rather, the specific features and acts are disclosed as exemplary forms of implementing the claimed systems, methods, and structures.

1. A system, comprising:
a touchscreen capable of sensing multiple simultaneous finger contacts;
an area of the touchscreen assigned for sensing the multiple simultaneous finger contacts, the area configured in real time to approximate a width of four fingers of one hand of a current user;
a database of touch patterns each assigned a character of an alphabet, the database comprising an alphabet of touch patterns;
the database of touch patterns including three types of touch patterns, including:
touch patterns composed of one single finger contact sensed on the area at a position in the area indicative of one of the four fingers in a given degree of extension;
touch patterns composed of two simultaneous finger contacts sensed on the area indicative of two of the four fingers in a given configuration; and
touch patterns composed of three simultaneous finger contacts sensed on the area indicative of three of the four fingers in a given configuration; and
a pattern identifier to associate a digital signal representing the assigned character of the alphabet with each touch pattern sensed by the area of the touchscreen.

2. The system of claim 1, wherein all characters of the alphabet of touch patterns comprise patterns formable by the fingers of one hand of the current user.

3. The system of claim 1, wherein the database of touch patterns enables the current user to communicate an entire alphabet with one hand using the alphabet of touch patterns without the current user visualizing the touchscreen and without the current user visualizing the area assigned for sensing the multiple simultaneous finger contacts;
wherein the touch patterns are composed of finger positions and configurations relative to the one hand of the user without regard for defined input keys on the assigned area of the touchscreen; and
wherein the assigned area of the touchscreen for sensing the multiple simultaneous finger contacts has no defined input keys.

4. The system of claim 1, further comprising a registration engine for designating the area of the touchscreen for input of the touch patterns, the area having a length approximating four adjacent simultaneous finger contacts of the four fingers of one hand of the current user, and a width approximately two-thirds of the length.

5. The system of claim 4, further comprising an region scaler to sense a size of a touch contact or a size of multiple touch contacts on the area of the touchscreen and to scale the area based on the size of the touch contact or the size of the multiple touch contacts.

6. The system of claim 4, further comprising an initiator for sensing four adjacent simultaneous finger contacts on the touchscreen to signal a host device to switch data input of the touchscreen to sensing the touch patterns representing the alphabet.

7. The system of claim 4, wherein the registration engine creates multiple instances of the area for sensing the touch patterns in different locations on a single touchscreen.

8. The system of claim 7, wherein each different instance of the area for sensing the touch patterns signals the pattern identifier to add a typographical emphasis to an assigned character of a touch pattern sensed by the respective area.

9. The system of claim 8, wherein the typographical emphasis is selected from the group consisting of a capitalization, an underline, an italics, a bold, a font style variation, and a font size variation.

10. The system of claim 7, wherein the alphabet is divided among the multiple instances of the area for sensing the touch patterns;
wherein for sensing the touch patterns the database of touch patterns is divided among the multiple instances of the area for sensing; and
wherein each different instance of the area assigns a different part of the alphabet of characters to touch patterns sensed in the respective instance of the area.

11. The system of claim 10, wherein each instance of the area for sensing the touch patterns senses a same set of the touch patterns but assigns characters from a respective different part of the alphabet to the touch patterns sensed in the respective instance of the area for sensing.

12. The system of claim 10, wherein each character of the alphabet is selected from the group consisting of an alphanumeric, an alphabet character, a letter, a number, a glyph, a segment, a script, and a symbol.

13. The system of claim 10, wherein the alphabet is associated with a language selected from the group consisting of Khmer (Cambodian), Devanagari, Sanskrit, Vedic Sanskrit, Persian, Kabardian, Abkhaz, Cyrillic, Slovak, Chinese, Spanish, Arabic, Georgian, Japanese, Japanese Hiragana, English, Russian, Korean, Hawaiian, Azeri, Italian, Malayalam, Armenian, Albanian, Mandarin, Latin, Han, and Greek.

14. A method, comprising:
assigning an area of a touchscreen for sensing multiple simultaneous finger contacts, the area configured in real time to approximate a width of four fingers of one hand of a current user;
storing a database of touch patterns each assigned a character of an alphabet, the database comprising an alphabet of touch patterns;
wherein the database of touch patterns includes three types of touch patterns, including:
touch patterns composed of one single finger contact sensed on the area at a position in the area indicative of one of the four fingers in a given degree of extension;
touch patterns composed of two simultaneous finger contacts sensed on the area indicative of two of the four fingers in a given configuration; and
touch patterns composed of three simultaneous finger contacts sensed on the area indicative of three of the four fingers in a given configuration; and
associating a digital signal representing the assigned character of the alphabet with each touch pattern sensed by the area of the touchscreen.

15. The method of claim 14, further comprising sensing characters of the alphabet of touch patterns, the entire alphabet formable by the fingers of one hand of the current user.

16. The method of claim 14, further comprising enabling the current user to communicate an entire alphabet with one hand using the alphabet of touch patterns without the current user visualizing the touchscreen and without the current user visualizing the area assigned for sensing the multiple simultaneous finger contacts.

17. The method of claim 14, further comprising creating multiple instances of the area for sensing the touch patterns in different locations on a single touchscreen.

18. The method of claim 17, further comprising configuring each different instance of the area for sensing the touch patterns to add a typographical emphasis to an assigned character of a touch pattern sensed by the respective area; and
wherein the typographical emphasis is selected from the group consisting of a capitalization, an underline, an italics, a bold, a font style variation, and a font size variation.

19. The method of claim 17, further comprising dividing the alphabet among the multiple instances of the area for sensing the touch patterns;
wherein for sensing the alphabet of touch patterns the database of touch patterns is divided among the multiple instances of the area for sensing;
wherein each different instance of the area assigns a different part of the alphabet of characters to touch patterns sensed in the respective instance of the area; and
wherein each character of the alphabet is selected from the group consisting of an alphanumeric, an alphabet character, a letter, a number, a glyph, a segment, a script, and a symbol.

20. The method of claim 19, wherein each instance of the area for sensing the touch patterns senses a same set of the touch patterns but assigns characters from a respective different part of the alphabet to the touch patterns sensed in the respective instance of the area for sensing.
